(19) United States
(12) Patent Application Publication
(10) Pub. No.: US 2012/0179561 A1
(43) Pub. Date: Jul. 12, 2012

(54) INTERACTIVE LOCATION-BASED SERVICE SYSTEM AND METHOD OF THE SAME

(76) Inventors: YUN-TING SUN, Taipei (TW); Hsiu-Ping Lin, Taipei City (TW)

(21) Appl. No.: 13/004,298

(22) Filed: Jan. 11, 2011

(51) Int. Cl. G06Q 30/00; G06F 17/00

(52) U.S. Cl. 705/26.3; 715/234

(57) ABSTRACT

The present invention may be related to a system of providing location-based service. The system may include a position module, a management module, a bid module and a map information module. The position module may be configured to receive first position information. The management module may be configured to receive product information and generate a product page based on the product information, wherein the product information may include at least one of a title, a price, a description, a picture, a voice introduction or a video of a product. The product page may show at least one of the title, the price, the description, the picture, the voice introduction or the video of the product. The bid module may be coupled to the product page and configured to receive a bid. Moreover, the map information module may be configured to correlate the product page with a position on a map based on the first position information.

### BACKGROUND OF THE INVENTION

The present invention relates to location-based service. More particularly, the present invention relates to system and method of providing location-based service that searched information or data around users.

Location-based service (LBS) or location service becomes more and more important in everyday life. Some LBS may be provided in a cellular phone (e.g., a smart phone) or a navigator (e.g., a GPS) as an application (i.e., software, perhaps including an electronic map or coupled with the electronic map, installed in the cellular phone or the navigator, or a widget specifically for coupling to a web or a system that provides an online map) for its user to find a point of interest (POI; that is a point on the map(s) of which the user of the cellular phone or the navigator is interested in looking, for). Traditionally, the execution of the application that provides this kind of LBS may include at least two steps: first, finding the location of the user through getting the positioning information of the cellular phone or the navigator (e.g., coordinates or longitude and latitude which are also sent by the cellular phone or the navigator), and second, receiving a keyword inputted by the user through an input field shown on the screen of the cellular phone or the navigator generated by the application (or in some examples, the keyword may be generated through voice recognition) to make the application or the online map system find POIs for the user based on the keyword (as search results).

Examples of the aforementioned web, system or online map can be found as an application (or a widget) called “Google Maps” (or simply called “Maps”) in cellular phones such as Google Nexus series, iPhones or some other kinds of smart phones. LBS that provide information (e.g., store location, advertisement, travel, real estate or daily life information) stored in the system or coupled to or associated with points on the maps can therefore be realized by providing keyword search to these information based on the user's location. Usually, these kinds of information are called “location information” or “map information”. The map information is stored in a server of the web or the system, and a search engine (perhaps installed in the same server or in another server coupled with the server having the map information) is provided for searching the map information based on the keyword.

In many countries, conventionally the map information is usually established/held and provided by a system provider (which also sets up the infrastruture of telecommunication systems or the cellular network including those telecommunication equipments such as base stations or relay stations for example, or held by a content provider such as Google or Yahoo who also provides the application (the widget) for cellular phones.

However, the aforementioned conventional map information (location information) can be classified into static information since this kind of information is not changed/modified rapidly, or seldom changed or even never changed. Updating the conventional map information may usually take a long while. For example, the system provider or the content provider of the LBS may adopt data mining techniques to webs on Internet to collect new map information, or assign their employee(s) or street view cars to make a circuit of (or travel around) an area, a district, a city or a whole country to take pictures or do interviews for receiving/collecting new location information (e.g., a newly opened store or a newly completed building on certain location/point(s)), and the engineer(s) who maintains the map will update (i.e., delete/change/modify/add) those should be updated corresponding to the newly received/collected location information related to the original point of the map to become new/updated map information on the map (e.g., based on coordinates or address they received the location information, etc). Note that the procedures that the system provider or the content provider intiatively update their map information on their map(s) may take a long time (a few days or even a few weeks) to collect the new location information and to update the new location information “manually” into their map.

Another example of updating map information on the aforementioned conventional map is when a merchant or a vendor registers the location information about his/her store into the system or the web. For example, the merchant may register the information including the address of the store or the product(s) it sells and the system provider or the content provider may make the registered store information associated with the point representing the address shown on the map after receiving the registered store information, and its corresponding map information for the store information is therefore formed on the map. The system or the web for the merchant to register his/her store information can still only provide “static” map information for the store (e.g., the name, the address, shop hours or telephone number of the store, the business items or the products sold in the store, etc., related to the point on the map), but cannot provide real-time/dynamic information about each product sold in the store (e.g., an item is sold out or not, remain how many or what size(s) of the item, arrival or not, when to arrival, the store is closed because of contingency, etc.). The conventional electronic/online map(s) cannot real-time take immediate reaction to the change of the aforementioned items for example.

Moreover, users of the conventional maps may have no direct ways to communicate or interact with the map information shown on the map. For example, the users may not be able to communicate with the merchant or ask the merchant a question about a product of a store found on the map by using the online map system or web directly (e.g., providers like Google does not provide a function like “ask the seller a question” as shown on eBay for a user to ask a question about one map information shown on their map directly. The users can only dial the phone number if the merchant makes his/her number be shown on the map and ask the merchant directly by phone).

Furthermore, in this example, there is no functions like “buy it directly,” “place a bid to buy” or “make a reservation,” etc., For the users to take an action (like web auction) to an item sold in the store shown/described in the map information on the aforementioned map. That is, the aforementioned map system or web may lack of “interactivity” that their user cannot interact with their map information (or say, with the merchant who generates or makes the map information be formed on the map) directly through the system or the web, but can only passively receive/accept what they find (the search result(s)) on the map (or say, can only accept what the system or the web gives them).

Drawbacks of the aforementioned map(s) may happen because of the poor interactivity or the lack of real-time changeable ability of the map information provided by the system or the web. For example, a user may go to a store after finding the store on the map in his cellular phone, but an item described in the corresponding map information he want is just sold out, or the merchant has already left the store ahead of its normal closing time.

Other conditions that the conventional map system or web cannot satisfy may be found as following:

In prior art, for example, LBS provided by the map system or web may not be capable of allowing a merchant or a seller to upload or update information about his/her product(s) to form a web page (as a web page for an auction item of eBay) and couple the web page to the conventional map(s) for the users of the map(s) to search and get the information of the product(s). Moreover, the map system usually do not provide management functions such as place a bid, decide the bid with highest price to win, conduct a question or an answer to its user or other purchase mechanism as a conventional auction web will do to its map information (or say, the item described in its map information).

On the other hand, the conventional map system or web cannot allow a user to real-time add/modify map information and real-time interact with the map information. Moreover, the timeliness of the map information is not emphasized on the conventional map since most of the conventional map information is static. For example, the available time or expiration time/date of the map information is not shown, and therefore when a user search and find the map information, he/she has no way to know it what described in the map information is still valid. This kind of map system or web cannot be used by the user in certain conditions, for example, to search for a person, a seller or a street vendor nearby who will only show up in next two hours on a corresponding point on the map(s).

Similarly, a seller (a merchant or a vendor) may not be able to provide information having timeliness or interactivity (e.g., “we will show up here in next twenty minutes,” “There is a time-limited sales promotion in next one hours,” or “please click the bottom to make a reservation for 1 hours,” etc.) to users who pass by (or will pass by) and may look for the map information about the merchant or the vendor's store or products through conventional map systems or webs.

Moreover, when a seller brings some products with him/her, theoretically he/she can sell the products to those near him/her and who wants to buy the products wherever he/she goes. This means if the seller wants the fact “he/she is here to sell the product” become map information for users of the map to search for and find the location of the product (i.e., the seller's current location) on the map, the location of the product may change time to time. However, the conventional map systems or webs may not support this kind of function to dynamically change the position information (the location or the coordinates) of its map information.

Other bottlenecks of the conventional map systems or webs can also be described in the following example:

One day, Joseph went to a district where he wants to buy a house. He tried to use a map shown on the screen of his cellular phone to search for houses around him and also satisfying his requirements. After searching, he found three houses (shown as map information on the map) that could meet his requirement and were sold by real estate brokers. Actually, one of the brokers, Mei, was walking on the street in same area but Joseph did not know then. However, because the map information is neither interactive nor real-time changed, Joseph could not get information about the status of Mei (who could be walking around him) and he could get introduction of the house from immediately.

Moreover, correctness of the map information is very important when providing the kind of location-based services. However, the conventional map information (or the map system or the web) of the prior art may usually be held and provided by specific companies or organizations (e.g., Google Inc. holds the map information on Google Maps), and thus the correctness of the map information can only be judged by the companies or the organizations. Furthermore, one may deliberately offer misleading or wrong map information on the conventional map for his/her own purpose (e.g., interests, advantages, etc.). For example, sometimes real estate brokers may post house information with indistinct or wrong point (location or address) on the map for the reason that the brokers do not want any potential buyers or customers to approach the owner of the house directly (i.e., to bypass the brokers for saving commission). Other example of misleading map information may be found if the aforementioned map system for the merchant/vendor to register their store/product information is not well-managed. One may intentionally registers his/her product information at many places of the map (i.e., to make the product information be coupled with/shown at many points on the map (even if these points are not related to his/her products or say a user cannot find the merchant/vendor at the location) in order to increase its exposure or to achieve the advertising validness. Wrong/Incorrect map information (or information correlated to wrong location) will make users confused, waste their time or even cause danger. It may therefore be desirable to have an anti-abuse measure/mechanism to prevent the map becoming improper advertising tools or criminal tools.

In addition, users of the conventional map systems or webs may seldom or never have chances to express their views or give their opinions directly to the correctness of the map information shown on the conventional maps by using any reporting or statement functions coupled with the point related to the map information (or the icon or web page showing the map information) on the conventional map(s). A system or a method for the users (or the public) to supervise the correctness of the map information shown on the map(s) may be necessary and helpful.

The original idea or the basic spirit of the location-based service should be to provide direct, correct, helpful and reachable (i.e., easy to obtain or approach) information surrounding the user's current location to the user immediately (or in real-time). Some of this kind of information should always be most updated (dynamic) for applications such as those mentioned above. Therefore, the static map information of the conventional map system or web may not be able to meet the requirements. Moreover, misleading map information should definitely not be allowable and a user of a map system should have right or a way to join the supervision of its map information.

Therefore, it is desirable to have an LBS system to satisfy the aforementioned needs.

### BRIEF SUMMARY OF THE INVENTION

Examples of the present invention may provide an LBS system. The system may include a position module, a management module and a map information module. The position module may be configured to receive first position information. The management module may be configured to receive product information and generate a product page based on the product information. The product information may include or be related to at least one of a title, a price, a description, a picture, a voice description or a video of a product. The product page may include at least one of the title, the price, the description, the picture, the voice description or the video of the product. Furthermore, the product page may be configured to couple with a communication module. The communication module may be configured to receive a question about the product. Moreover, the map information module may be configured to couple the product page with a location on a map based on the first position information.

Some examples of the present invention may provide an LBS system. The system may include a position module, a management module and a map information module. The position module may be configured to receive first position information. The management module may be configured to receive message information and a value of an expiration time, and generate a web page including the message information. The management module may further include a timer module configured to count the time after the web page is generated and the management module may be configured to decide if the web page is valid or should be shown when/after comparing the time and the value of the expiration time. The message information may include at least one of a title, a description, a picture, a voice description or a video. The web page may include at least one of the title, the description, the picture, the voice description or the video. Moreover, the map information module may be configured to couple the web page with a location on a map according to the first position information.

Examples of the present invention may also provide a method of providing location-based service. The method may include receiving first position information; receiving product information, wherein the product information include at least one of a title, a price, a description, a picture, a voice description or a video of a product; generating a product page based on the product information, wherein the product page may include at least one of the title, the price, the description, the picture, the voice description or the video of the product; and coupling the product page with a location on a map based on the first position information.

Other examples of the present invention may provide a method of providing location-based service. The method may include receiving first position information; receiving message information and a value of an expiration time, and generating a web page including the message information, wherein the message information may include at least one of a title, a description, a picture, a voice description or a video, wherein the web page may include at least one of the title, the description, the picture, the voice description or the video; Counting the time after the web page is generated or from the time the web page is set to be valid; Comparing the time and the value of the expiration time to decide if the web page is valid or should be shown; and coupling the web page with a location on a map based on the first position information.

Some examples of the present invention may provide an LBS system. The system may include a position module, a management module and a map information module. The position module may be configured to receive first position information. The management module may be configured to receive product information and generate a product page based on the product information. Moreover, the management module may include a bid module coupled to the product page and configured to receive a bid. The map information module may be configured to couple the product page with a location on a map according the first position information.

Some examples of the present invention may provide a method of providing location-based service. The method may include: receiving first position information; receiving product information and generating a product page based on the product information; receiving a bid through a bid field coupled to the product page; and coupling the product page with a location on a map based on the first position information.

Some examples of the present invention may also provide an LBS system. The system may include a position module, a management module and a map information module. The position module may be configured to receive first position information and updated position information after the first position information. The management module may be configured to receive product information, and generate a product page based on the product information. The map information module may be configured to couple the product page with a first location on a map corresponding to the first position information. Moreover, the map information module may couple the product page with a second location on the map corresponding to the updated position information when the position module receives the updated position information.

Other examples of the present invention may provide a method of providing location-based service. The method may include: receiving first position information; receiving product information, and generating a product page based on the product information; coupling the product page with a location on a map based on the first position information; receiving updated position information about the product information; and coupling the product page with the updated position information when receiving the receive updated position information.

Other examples of the present invention may also provide an LBS system. The system may include a position module, a management module, a map information module and a report module. The position module may be configured to receive first position information. The management module may be configured to receive product information, and generate a product page based on the product information. The map information module may be configured to couple the product page with a location on a map according the first position information. Moreover, the report module may be configured to receive a report indicating the location in connection with the product page is incorrect.

Examples of the present invention may provide a method of providing location-based service. The method may include: receiving first position information; receiving product information; generating a product page based on the product information; coupling the product page with a location on a map based on the first position information; and receiving a report indicating the location in connection with the product page is incorrect.

Examples of the present invention may also provide a first application module. The first application module may be configured to receive first position information, transmit product information and show a tag or an icon coupled to a product page corresponding to the product information and located at a location representing the first position information on a map. The product information may include or be related to at least one of a title, a price, a description, a picture, a voice description or a video of a product. The product page may include at least one of the title, the price, the description, the picture, the voice description or the video of the product.

In these examples, the first application module may further include an instant messenger configured to receive a question about the product and/or send an answer about the question.

In these examples, the product page may further include a bid field configured to place a bid to make an offer to purchase the product, to purchase the product directly, or reserve the product.

In these examples, the product page may further include a report button configured to generate a report to indicate the location related to the product page is incorrect on the map.

In these examples, the first application module may be configured to receive updated position information (or current position information received by the first application module) and send the updated position information to change the location related to the product page on the map. The product page will be coupled to a new point on the map according to the updated position information after the first application module sends the updated position information. In these examples, the first application module may send the updated position information only if the change of the position information received is larger than or equal to a difference limitation.

Examples of the present invention may also provide a second application module. The second application module may be configured to receive second position information, transmit a keyword for searching product information about a product related to the keyword and show a tag or an icon coupled to a product page corresponding to the product information and located at a location representing position information near the second position information on a map. The product information may include or be related to at least one of a title, a price, a description, a picture, a voice description or a video of a product. The product page may include at least one of the title, the price, the description, the picture, the voice description or the video of the product.

In these examples, the second application module may further include an instant messenger configured to send a question about the product and/or receive an answer about the question.

In these examples, the product page may further include a bid field configured to make an offer to purchase the product, to purchase the product directly, or reserve the product.

In these examples, the product page may further include a report button configured to generate a report to indicate the location related to the product page is incorrect on the map.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

In the drawings:

FIG. 1A is a block diagram illustrating a location-based service system according to an example of the present invention;

FIG. 1B is a block diagram illustrating a location-based service system according to another example of the present invention;

FIG. 1C is a block diagram illustrating a location-based service system according to still another example of the present invention;

FIG. 2A is a diagram illustrating an input window for the first position information according to an example of the present invention;

FIG. 2B is a diagram illustrating an input window for the product information according to an example of the present invention;

FIG. 2C is a diagram illustrating a communication-module-related window according to an example of the present invention;

FIG. 2D is a diagram illustrating a communication-module-related window according to another example of the present invention;

FIG. 3A is a diagram illustrating an input window for the second position information according to an example of the present invention;

FIG. 3B is a diagram illustrating an product-page window according to an example of the present invention;

FIG. 3C-1 is a diagram illustrating a communication-module-related window according to an example of the present invention;

FIG. 3C-2 is a diagram illustrating a communication-module-related window according to an example of the present invention;

FIG. 3C-3 is a diagram illustrating a communication-module-related window according to an example of the present invention;

FIG. 3D is a diagram illustrating a search-field window according to another example of the present invention;

FIG. 3E-1 is a diagram illustrating a search-result window according to another example of the present invention;

FIG. 3E-2 is a diagram illustrating a search-result window according to another example of the present invention;

FIG. 3F-1 is a diagram illustrating an product-page window according to another example of the present invention;

FIG. 3F-2 is a diagram illustrating a report window according to another example of the present invention;

FIG. 4A is a block diagram illustrating a location-based service system according to an example of the present invention;

FIG. 4B is a block diagram illustrating a location-based service system according to another example of the present invention;

FIG. 4C is a block diagram illustrating a location-based service system according to still another example of the present invention;

FIG. 5A is a diagram illustrating input window for the message information according to an example of the present invention;

FIG. 5B is a diagram illustrating a communication-module-related window according to an example of the present invention;

FIG. 5C is a diagram illustrating a communication-module-related window according to an example of the present invention;

FIG. 6A is a diagram illustrating a web-page window according to an example of the present invention;

FIG. 6B-1 is a diagram illustrating a communication-module-related window according to an example of the present invention;

FIG. 6B-2 is a diagram illustrating a communication-module-related window according to an example of the present invention;

FIG. 6B-3 is a diagram illustrating a communication-module-related window according to an example of the present invention;

FIG. 6C-1 is a diagram illustrating a search-result window according to another example of the present invention;

FIG. 6C-2 is a diagram illustrating a search-result window according to another example of the present invention;

FIG. 6D-1 is a diagram illustrating a web-page window according to another example of the present invention;

FIG. 6D-2 is a diagram illustrating a broken-appointment window according to another example of the present invention;

FIG. 7 is a flowchart illustrating a method of providing a location-based service according to an example of the present invention;

FIG. 8 is a flowchart illustrating a method of providing a location-based service according to another example of the present invention;

FIG. 9A is a flowchart illustrating a method of providing a location-based service according to still another example of the present invention;

FIG. 9B is a flowchart illustrating a method of providing a location-based service according to yet another example of the present invention;

FIG. 10A is a flowchart illustrating a method of providing a location-based service according to still another example of the present invention;

FIG. 10B is a flowchart illustrating a method of providing a location-based service according to yet another example of the present invention;

FIG. 11A is a flowchart illustrating a method of providing a location-based service according to still another example of the present invention;

FIG. 11B is a flowchart illustrating a method of providing a location-based service according to yet another example of the present invention;

FIG. 11C is a flowchart illustrating a method of providing a location-based service according to still another example of the present invention;

FIG. 12A is a flowchart illustrating a method of providing a location-based service according to still another example of the present invention;

FIG. 12B is a flowchart illustrating a method of providing a location-based service according to yet another example of the present invention;

FIG. 13 is a flowchart illustrating a method of providing a location-based service according to still another example of the present invention;

FIG. 14 is a flowchart illustrating a method of providing a location-based service according to yet another example of the present invention;

FIG. 15A is a flowchart illustrating a method of providing a location-based service according to still another example of the present invention;

FIG. 15B is a flowchart illustrating a method of providing a location-based service according to yet another example of the present invention;

FIG. 16A is a flowchart illustrating a method of providing a location-based service according to still another example of the present invention;

FIG. 16B is a flowchart illustrating a method of providing a location-based service according to yet another example of the present invention;

FIG. 16C is a flowchart illustrating a method of providing a location-based service according to still another example of the present invention;

FIG. 17A is a flowchart illustrating a method of providing a location-based service according to still another example of the present invention; and

FIG. 17B is a flowchart illustrating a method of providing a location-based service according to yet another example of the present invention.

### DETAILED DESCRIPTION OF THE INVENTION

Reference will now be made in detail to the present examples of the invention, examples of which are illustrated in the accompanying drawings. Wherever possible, the same reference numbers will be used throughout the drawings to Referring to the same or like parts.

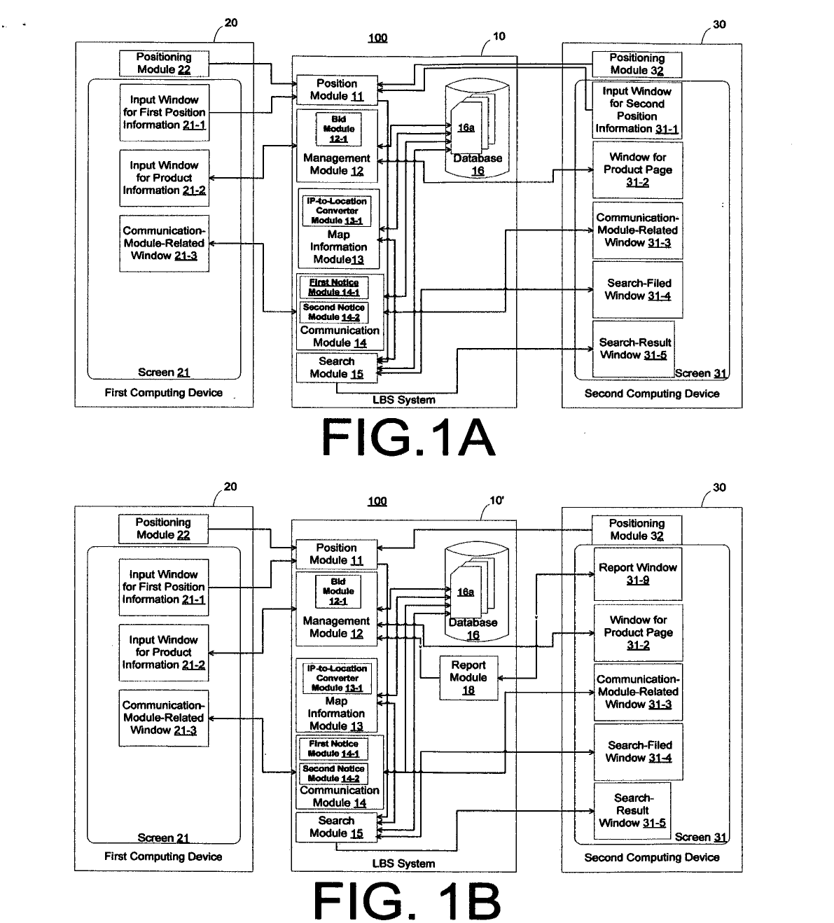

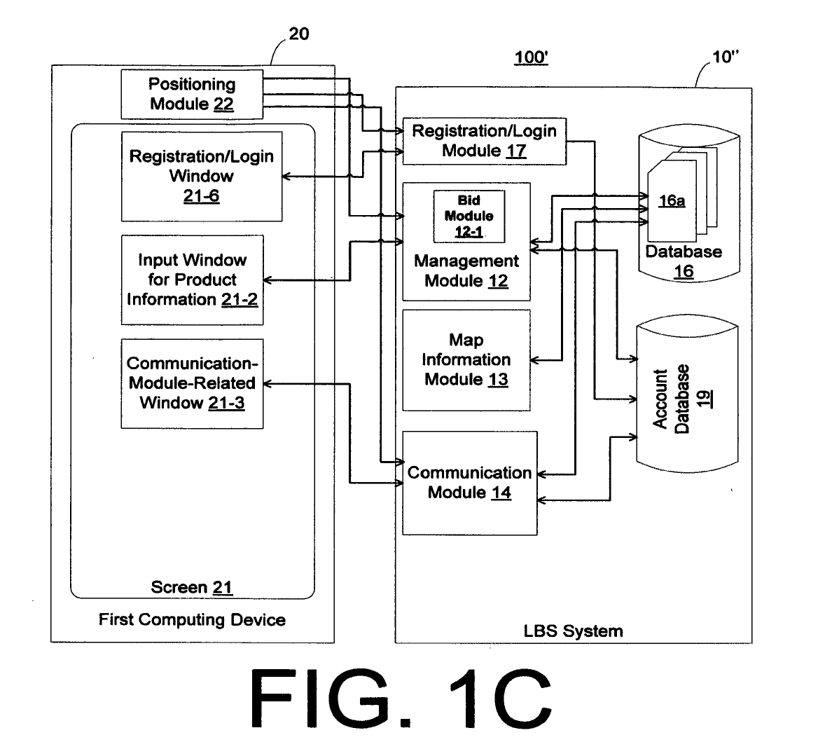

FIG. 1A is a block diagram illustrating a location-based service (LBS) system 10 according to an example of the present invention. Referring to FIG. 1A, the LBS system 10 may couple to a first computing device 20 or a second computing device 30. In one example, the LBS system 10 may be formed, installed or configured in a server. In another example, the first computing device 20 or the second computing device 30 may include at least one of a television (TV), a personal computer (PC), a laptop or notebook, a cellular phone (mobile phone), a personal digital assistant (PDA), a navigator (GPS), a digital camera, a video camera, a projector or a device equipped with a projector module, a mobile device, a portable media player (PMP), an electronic book (e-book), a web pad (webpad), an information appliance (IA), a walk-man or MP3 player, a TV gamer, a handheld gamer, an electronic dictionary or a car computer.

The LBS system 10 may include a position module 11, a management module 12 and a map information module 13. The position module 11 may be configured to receive first position information. The first position information may include at least one of latitude and longitude (coordinates), a name of an attraction or a landmark that can be used to identify one's current location (e.g., “I am near the Golden Gate Bridge”, etc.), an address or an IP address come from the first computing device 20. In one example, the first computing device 20 may send the first position information, such as its coordinates received by a GPS module (which usually has an antenna to receive GPS signals including coordinates from satellites and a GPS chip for demodulating/decoding the GPS signals) embedded in the first computing device 20, related to its location to the LBS system 10. In another example, the position module 11 may be implemented as a program (or subprogram) or a routine (or subroutine) of the LBS system 10 run by a CPU or its co-processor for executing the receiving job of the first position information and conducting the first position information to related parts of the LBS system 10. In still another example, the position module 11 may be implemented as a specific hardware module, for example, a card mounted with a chip including at least a part of an ASIC doing the receiving job for receive the first position information to couple with the other parts of the LBS system 10 (perhaps to be inserted in a slot of the server that includes/runs the LBS system 10). Those skilled in the art can easily understand that a hardware-implemented position module may take advantages as being executed faster than a software-implemented position module, but its cost may be higher.

The management module 12 may be configured to receive product information, and generate a product page 16a based on the product information. The management module 12 may generate/open an input window 21-2 coupled to the management module 12 and configured to receive input about the product information inputted by a user (or a seller). In one example, the product information, usually transmitted as a bit stream (or a packet) through a communication channel (i.e., the channel from the first computing device 20 to the LBS system 10, for example, through internet or cellular network including telecommunication equipment), may include or be related to at least one of a title (e.g., include the name of the product), a price, a description, a picture, a voice description or a video of a product. In this example, the product information may be filled into corresponding field of a template by the management module 12 to form the product page 16a (e.g., the template may include a title field for the title of the product page, and the title included in the product information may be filled into the title field correspondingly by the management module 12 for forming the product page 16a, and so on).

The product page 16a may show at least one of the title, the price, the description, the picture, the voice description or the video of the product. The product page 16a may be stored in a database 16. In one example, the product page 16a may be stored in the database 16 as a file including HTML or XML codes related to the product information (e.g., it may be stored as a file named “xxx.htm”, etc.). When the second computing device 30 receives the product page 16a, it may apply a compiler or a browser to compile/parse the HTML codes or the XML codes and show the product page 16a in a window (e.g., the window 31-2 for product pages) on a screen 31 of the second computing device 30 (i.e., the product page 16a is stored as the file including the HTML or XML codes in the database 16, and will be transmitted as a bit stream (or a packet) to the second computing device 30 to be compiled or parsed and shown as a web or within the window 31-2 on the screen 31).

The management module 12 may further include a bid module 12-1. In one example, the product page 16a may include a bid field for a user to place a bid to the product described on the product page 16a. The bid module 12-1 in this example is capable of being coupled with the bid field of the product page 16a to receive the bid. Moreover, the bid module 12-1 may be configured to be used to set up a sale duration (selling period) and a minimum reserve, wherein the sale duration is the duration that the user can place bids on the product through the product page 16a, and thus the sale duration can be used to identify if the product page 16a is valid (valid or not valid depends on the sale duration expires or not). For example, if the sale duration of the product page 16a expires, the window 31-2 will show that the item (product) is ended or the product page 16a (or the product) is removed, or the bid module 12-1 (the bid field of the product page 16a) can no longer receive a bid or a question, etc. Once the sale duration expires, no further actions can be done to the product page 16a. The minimum reserve can be used to identify/determine if a bid is effective (valid) or not based on if an offer (i.e., a price that the user is willing to or wants to purchase the product) of the bid is higher than the minimum reserve or not. The bid will be considered as effective if the offer of the bid is higher than the minimum reserve. In other example, after receiving the bid, a communication module 14 (included in the LBS system 10) may send a notice to let the seller who sells the product through the product page 16a know that someone has placed a bid on his/her item (or someone is interested in his/her product).

In another example, the bid module 12-1 may be configured to set up a buy-it-directly price. In this example, the bid module 12-1 may couple to a bid field of the product page 16a to receive a bid from a user through the bid field. Once the bid module 12-1 receives the bid, which means the user wants to buy the product with the buy-it-directly price, the status of the product shown on the window 31-2 will become “sold (or sold out)”. In still other example, after receiving the bid, the communication module 14 may send a notice to let the seller who sells the product through the product page 16a know that someone confirms to purchase the product with the buy-it-directly price.

In other example, similarly, the bid module 12-1 may couple to a bid field of the product page 16a to receive a bid, wherein the status of the product shown on the window 31-2 will become “reserved” once the bid module 12-1 receives the bid. That is, when the product page 16a including the bid field is shown as the window 31-2 on the screen 31 of the second computing device 30, if a user places the bid to the bid module 12-1 through the bid field, it means the user wants to reserve the product (or an item of the product) or make reservation on the product (perhaps the product is intangible such as providing a service like hair-cutting, spa or booking a table, etc.). Those skilled in the art can easily understand that, in examples of the present invention, the product does not necessarily be a tangible good. Services are another kind of products and thus the product mentioned in this specification should not be limited to be tangible. In yet other example, after receiving the bid, the communication module 14 may send a notice to let the seller know the user wants to make a reservation on his/her product.

Those skilled in the art can easily understand that the management module 12 may be configured/implemented as a program (or subprogram) or a routine (or subroutine) installed or run by a processor (perhaps a CPU or its co-processor) of the server including the LBS system 10 to achieve/provide the abovementioned function. In other example, the management module 12 may be configured/implemented as a specific hardware module, for example, at least a part of an ASIC providing the abovementioned function within the LBS system 10. Those skilled in the art can easily understand that a hardware-implemented management module may take advantages that it can be executed faster than a software-implemented management module. However, the former may cost higher than the later.

From the abovementioned examples of the present invention, the product page 16a may be configured to couple with the communication module 14. In addition to the notices) sent in the abovementioned situation (s), the communication module 14 may also be configured to receive a question about the product (to ask the seller about the product). The communication module 14 may include a first notice module 14-1 configured to send a first notice to inform the seller (or the user who carries or posts the product page 16a) of the product someone has asked a question to his/her product (e.g., color(s), size(s), arrival time(s), etc.).

The communication module 14 may also be configured to receive an answer provided by the seller about the question. Moreover, the communication module 14 may include a second notice module 14-2 configured to send a second notice to inform the user who asks the question his/her question has been answered when the communication module 14 receives the answer.

The aforementioned mechanisms or methods of applying the modules of the LBS system 10 to ask questions and receive answers will be further described and illustrated in examples hereinafter.

In still another example, at least one of first notice module 14-1 or the second notice module 14-2 may include at least one of a question and answer (Q&A) module, an e-mail module or an instant messenger module (instant messenger or IM). The Q&A module may be configured to provide a input field on the window 31-2 or another window called communication-module-related window 31-3 for the user to enter/submit his/her questions and receive/see the answers. The e-mail module may be used to send the first or the second notice by emails to inform the user or the seller. In one example, the emails may include not only the notices but also the contents of the question or the answer. The IM may be configured to peer-to-peer transfer the notices, and the notices will be shown in the communication-module-related window 31-3 directly or immediately once the question or the answer is received. Those skilled in the art can easily understand that the first notice module 14-1 can be implemented as a first instant messenger and the second notice module 14-2 can be implemented as a second instant messenger, separately, wherein the former solely handles a job (or jobs) of sending a first message when the communication module 14 receives a question about the product, while later solely handles a job (or jobs) of sending a second message when the communication module 14 receives an answer related to the question about the product.

Similarly, the communication module 14 may be configured/implemented as a program (or subprogram) or a routine (or subroutine) installed or run by a processor (perhaps a CPU or its co-processor) of the server including the LBS system 10 to achieve/provide the abovementioned function. In other example, the communication module 14 may be configured/implemented as a specific hardware module, for example, at least a part of an ASIC providing the abovementioned function within the LBS system 10. Those skilled in the art can easily understand that a hardware-implemented communication module may take advantages that it can be executed faster than a software-implemented communication module. However, the former may cost higher than the later.

In other example, a communication-module-related window 21-3 coupled with the communication module 14 and shown on the screen 21 of the first computing device 20 may be configured to receive input about the answer, the first notice, the question or other notice.

Therefore, the communication-module-related window 31-3 coupled with the communication module 14 and shown on the screen 31 of the first computing device 30 may be configured to receive input about the question, the second notice, the answer about the question or other notice.

The map information module 13 may be configured to couple the product page 16a to a location (or a point) on a map based on or corresponding to the first position information. In one example, the first position information may include at least one of latitude and longitude (or coordinates), a name of an attraction or a landmark, an address or an LP address related to the product page and the map information module 13 may be configured to find a location (or a point) related/corresponding to the at least one of the latitude and longitude, the name of the attraction or the landmark, the address or the IP address, and couple the product page 16a to the location on the map.

In one example, the latitude and longitude (the coordinates) may be usually received by the GPS module in the first computing device 20 as discussed above. A positioning module 22 formed in the first computing device 20 (and perhaps coupled with the GPS module) may receive the latitude and longitude (the coordinates) from the GPS module and send the latitude and longitude (the coordinates) to the position module 11. Similarly in one example, the positioning module 22 may be configured/implemented as a program (or subprogram) or a routine (or subroutine) installed or run by a processor (perhaps a CPU or a microprocessor/micro-controlling unit or micro-controller) of the first computing device 20 to execute jobs of receiving the first position information and sending the first position information to the position module 11 of the LBS system 10. In another example, the positioning module 22 may be configured/implemented as a specific hardware module, for example, at least a part of an ASIC doing the receiving job for receive the first position information and redirecting the first position information to the position module 11 of the LBS system 10. Again, those skilled in the art can easily understand that a hardware-implemented positioning module may take advantages as being executed faster than a software-implemented positioning module. However, the former may cost higher than the later.

In another example, a user may input a name of an attraction or a landmark, such as a name of a place, a tour attraction, a bus or train stop/station or a historic spot to the LBS system 10 through an input window 21-1 coupled with the position module 11. The map information module 13 coupled with the position module 11 to receive the first position information may be configured to parse the words (or keyword(s)) of the name of the attraction or the landmark and look for its corresponding location (point) on the map.

In other example, the IP address may be used to identify it corresponding location on the map. In this example, the map information module 13 may further include an IP-to-location converter module 13-1. The IP-to-location converter module 13-1 may be configured to find the location corresponding to the IP received on the map, since each packet transmitted in internet may comprises an IP address of where it from, and usually a server who redirects or handles the routing of the packet may also maintain a mapping table for IP address and its corresponding physical address in the world. The IP-to-location converter module 13-1 may look up the mapping table (perhaps through internet) to find the corresponding location and treat it as the location of the first computing device 20 on the map.

Note that the position module 11 and the map information module 13 may be configured to provide the same or similar function(s) as aforementioned to a positioning module 32 formed in the second computing device 30 to receive second position information related to the location of the second computing device on the map.

Moreover, in one example, the map information module 13 may be configured to identify or to mark the location related to the product page 16a as an icon shown on the map (e.g., a balloon), and at least one of a tag, the window 31-2 showing the product page 16a or a link (or a hyperlink) linking to the product page 16a will be shown once the icon is clicked or selected by a user. In this example, the tag may include at least one of the title, the price, the description, the picture, the voice description or the video of the product page 16a.

In one example, the map information module 13 may be configured/implemented as a program (or subprogram) or a routine (or subroutine) installed or run by a processor (perhaps a CPU or its co-processor) of the server including the LBS system 10 to achieve/provide the abovementioned function. In other example, the map information module 13 may be configured/implemented as a specific hardware module, for example, at least a part of an ASIC providing the abovementioned function within the LBS system 10. Those skilled in the art can easily understand that a hardware-implemented map information module may take advantages that it can be executed faster than a software-implemented map information module. However, the former may cost higher than the later.

Further, the LBS system 10 may include a search module 15. The search module 15 may be configured to receive a keyword and the second position information (i.e. about the location of the second computing device 30). The keyword may be entered through a search field 323 shown in a search-field window 31-4, or recognized from a word pronounced by a user by the help of voice recognition to form a keyword.

Similarly, the second position information may include at least one of latitude and longitude (coordinates), a name of an attraction or a landmark, an address or an IP address related to the location of the second computing device 30 (which is also used to send the keyword). In addition, the search module 15 may be configured to compare the keyword with words in at least one of product information, product pages (including the product page 16a perhaps) or icons related to locations (or the corresponding points to the locations) within a range (perhaps a predetermined range) near the location on the map corresponding to the second position information or centered by the location on the map corresponding to the second position information to find at least one of product information, a product page or an icon related to the keyword as a search result if the at least one of product information, the product pages or icons related to the keyword exists. Moreover, the scope of the range may be designed to be settable or adjustable depending on domain(s), type(s) or area a use wants to search or the domain(s) the keyword belongs to. For example, a first range adopted to search for a real estate may be larger/bigger than a second range used to search for a hamburger.

Moreover, the map information module 13 may be configured to show a region of the map (or a part of the map) including at least a part of the range centered by the location corresponding to the second position information or near the location corresponding to the second position information on the map in a search-result window 31-5 shown on the screen 31 of the second computing device 30 to locate the search result generated by the search module 15 with respect to the keyword. In one example, the search module 15 may be configured to mark the location of or related to the search result as the icon or the tag in the region, wherein the icon or the tag is configured to link to or to show at least one of corresponding product page or product information if the icon or the tag is pressed, clicked or selected.

In one example, the search module 15 may be configured/implemented as a program (or subprogram) or a routine (or subroutine) installed or run by a processor (perhaps a CPU or its co-processor) of the server including the LBS system 10 to achieve/provide the abovementioned function. In other example, the search module 15 may be configured/implemented as a specific hardware module, for example, at least a part of an ASIC providing the abovementioned function within the LBS system 10. Those skilled in the art can easily understand that a hardware-implemented search module may take advantages that it can be executed faster than a software-implemented search module. However, the former may cost higher than the later.

Moreover, those skilled in the art can easily understand that the aforementioned position module 11, management module 12, map information module 13, communication module 14 and/or search module 15 may be embodied as hardware (e.g., combinational logic, circuit, or a chip), software or partially hardware and partially software (or firmware). In the software embodiment of the present invention, the CPU of the server (not shown) may execute the software program (or programming codes) about at least one of the modules of the LBS system 10 stored in storage or memory of the server (also not shown) or control at least some of the modules of the LBS system 10 to achieve the corresponding aforementioned functions of the LBS system 10.

Moreover, as the LBS system 10 functions, corresponding user interface(s) or window(s) may show on the screen 21 of the first computing device 20 or the screen 31 of the second computing device 30. In one example, the screen 21 may show the input window 21-1 coupled with the position module 11 and configured to receive input about the first position information inputted by the user (or the seller) who uses the first computing device 20. In another example, the screen 21 may show the input window 21-2 coupled with the management module 12 and configured to receive input about the product information inputted by the user (or the seller). In other example, the screen 21 may show the communication-module-related window 21-3 coupled with the communication module 14 and configured to receive input about an answer, the first notice, the question or other notice.

Moreover, those skilled in the art can also understand that if the first computing device 20 includes the GPS module and the positioning module 22 is configured to couple with the GPS module for receiving the coordinates of the first computing device 20, then the input window 21-1 is not necessary since the coordinates (i.e., the first position information) can be automatically received by the positioning module 22 from the GPS module and sent to the position module 11.

Similarly, the screen 31 may show a input window 31-1 coupled with the position module 11 and configured to receive input about the second position information from for a user (or a buyer). Those skilled in the art can also understand that if the second computing device 30 includes the GPS module and the positioning module 32 is configured to couple with the GPS module for receiving the coordinates of the second computing device 30, then the input window 31-1 is not necessary.

In prior art, position information of map information is always fixed (e.g., the coordinates of a gas station may not change every hour). However, by adopting the LBS system 10 of the present invention, position information of map information (i.e., the aforementioned shown on the map) can change frequently. For example, position information of a real-estate broker may be changing every hour since he/she may show up in different locations of houses he/she sells/introduces. Online shopping embodied by the LBS system 10 of the present invention could be another example. In this example, a seller may go anywhere and sell product he/she brings and thus his/her location on the map of the LBS system 10 may need to be changed according to his/her updating coordinates every minute or hour.

To this end, the positioning module 22 (which may be formed in the seller or the broker's first computing device) may receive updated position information from the GPS module after the first position information and send the updated position information (or the updating position information) to the position module 11 frequently (or periodically). Then the map information module 13 may couple the product page with a new location on the map corresponding to the updated position information when the position module 11 receives the updated position information.

In one embodiment of the present invention, the period that the positioning module 22 sends updated position information according to can designed to be changeable or adjustable by the user (e.g., the seller or the broker) or the system designer of the LBS system 10.

Since periodically/frequently sending position information to the position module 11 may consume battery power of the first computing device, in one embodiment of the present invention, the positioning module 22 may send new position information as the updated position information to the position module 11 only when the difference between the new position information and the previous position information (i.e., the position information the position module 11 receives from the UPS module last time) or the first position information is larger than or equal to a difference limitation (which means the seller or the broker has left “far enough” from his/her original location).

In one example, the management module 12 may also be configured to execute at least one of showing the product page 16a is invalid, cancelling the product page 16a or withdrawing the product page 16a when the difference between the updated position information and the first position information is larger than or equal to a difference limitation.

FIG. 1B is a block diagram illustrating an LBS system 10′ according to another example of the present invention. Referring to FIG. 1B, the LBS system 10′ may be similar to the LBS system 10 described and illustrated with reference to FIG. 1A, except that the LBS system 10′ may further include a report module 18 and may cause the screen 31 of the second computing device 30 to show a report window 31-9 coupled with the report module 18. In conventional location-based service field, users may seldom or never have chances to express their views or give their opinions to the correctness of map information shown on an electronic map. For example, if the map information is changed (e.g., a store is closed down, a house is rebuilt or a road is changed), a user may have to arrive the point to find the change, and it may waste time or make the user confused. To the LBS system 10′ of the present invention, the map information includes the product information, and the product information may change more rapidly than the change of the map information of those prior art. For example, a product may be sold out anytime, or a seller may add or cancel a product page immediately and these could may the map information of the map provided by the LBS system 10′ change rapidly. Therefore, when the user (e.g., a customer) arrives a place which is marked as the location on the map related to the product page 16a (or related to the product information), if he/she found the location shown on the map is incorrect (e.g., can't find the seller or the product being sold at the place, etc.), he/she can use his/her cellular phone (i.e., the second computing device 30) to open the report window 31-9 on its screen 31, and push (click, press of select) a report button 399 to generate a report to the LBS system 10′ (will be described and illustrate with reference to FIG. 3F-1 and 3F-2) to indicate that the location of the product page 16a is incorrect.

The report module 18 may be configured to receive the report indicating the location in connection with the product page 16a is incorrect. In one example, the report module 18 may cause the management module 12 to execute at least one of showing the product page 16a is invalid (or the location of it is incorrect), cancelling the product page 16a, withdrawing the product page 16a or making other users cannot place a bid through the product page 16a.

Sometimes, if the management module 12 takes the above-mentioned action(s) to the product page 16a only based on a single user's report, it may be unfair since, for example, a competitor of the seller of the product page 16a may deliberately try this way to cause the product page 16a to be cancelled. In order to prevent the report module 18 from becoming a tool for this kind of vicious competition, in one example, the report module 18 may be configured to count the number of reports generated by different users about the product page 16a, and the report module 18 will cause the management module 12 to execute the at least one of showing the product page 16a is invalid, cancelling the product page 16a or withdrawing the product page 16a if the number of reports achieves or exceeds a first limited number. Note that in some examples the first limited number could also be set as “1” and it will cancel the place a bid function of the product page or causes the product page 16a be cancelled or marked as invalid if the product page 16a is reported once.

Moreover, in order to ensure the effectiveness of the report, to location-based service field, it may be suitable to follow the rule—“to see is to believe”. Therefore, the report module 18 may be configured to compare position information of the second computing device the use uses to generate the report with the first position information related to the product page 16a (i.e., the location shown on the map), and the report will be determined to be valid only if the difference between the two position information is smaller or equal to a difference limitation, which means when generating the report, only if the user's location is really close to the location related to the product page 16a, he/she can judge if the location is wrong or right.

Moreover, in still another example, the report module 18 may be configured to count the number of the abovementioned valid reports generated by different users to the product page 16a, and the report module 18 will cause the management module 12 to execute the at least one of showing the product page 16a is invalid, cancelling the product page 16a or withdrawing the product page 16a if the number of valid reports achieves or exceeds a second limited number. Note that in some examples the second limited number could also be set as “1”.

FIG. 1C is a block diagram illustrating an LBS system 10″ according to still another example of the present invention. Referring to FIG. 1C, the position module 11, the search module 15 and some windows on the screen 21 or 31 that related to the modules 11 and 15 are not shown for simplifying the illustration. The LBS system 10″ may be similar to the LBS system 10 or 10′ described and illustrated with reference to FIG. 1A or 1B, except that the LBS system 10″ may further include a registration/login module 17. The registration/login module 17 may be coupled with an account database 19. Also, the registration/login module 17 may cause the screen 21 of the first computing device 20 to show a registration/login window 21-6 coupled with the registration/login module 17.

In prior art, a system (e.g., a website) or a widget coupled to a remote server or system may identify identification of a user (or a member) comparing an account and a password entered by the user or codes included in a card or a device for the system to detect or recognize (e.g., IMEI in a cellular phone or a serial number of a USB drive) with the an account and its password or codes set or stored in database (e.g., user database) of the system to check if the two are matched or identical. Traditionally the passwords or codes are usually composed of characters, and it is possible to be guessed or cracked.

Moreover, when executing a login procedure, except providing a field for entering passwords, some systems or websites may also provide a figure together with another field for a user to enter characters, symbols or numbers corresponding to what he/she reads in the figure. The purpose of this is to prevent a hacker to use a robot to attack/crack the systems because only humans can recognize the characters, symbols or numbers shown in the figure. However, it may still be cracked by applying image recognition to the figure each time and sometimes it is not convenient for a user to see the figure and enter characters according to the figure.

Therefore, the LBS system 10″ of the present invention may provide a mechanism to identify identification of a user by comparing his/her current position information and position information registered with his/her account, except that to ask the user to enter his/her codes, account or password(s). It may increase a level of protection from hacking or cracking the LBS system 10″ since the position information registered in the LBS system 10″ may not easily be known (e.g., it may be latitude and longitude having many digits) and also be convenient since positioning modules in the computing devices coupled to the LBS system 10″ may be configured to send current position information it receives when the user tries to login the system, and the LBS system 10″ may compare the current position information and a registered position information related to an account automatically.

The registration/login module 17 may be configured to record position information related to an account into the account database 19 when the account is registered. In this example, the registration/login module 17 may be configured to receive data including the account, a password related to the account or other personal details entered by a user (e.g., a seller) who wants to register the account into the LBS system 10″ through the registration/login window 21-6 coupled with the registration/login module 17. When registering the account, position information related to the user may also be registered and stored in the account database 19. In one example, the registered position information may come from an address entered in the registration/login window 21-6 by the user when registering, and the registration login module 17 may look up position information corresponding to the address entered as the registered position information. In another example, the registered position information may come from position information received by the positioning module 22 when the user registered his/her account (i.e., the position information of the first computing device 20 when it is used by the user to register the account).

In this example, the registration/login module 17 may be configured to compare current position information of the first computing device 20 when the first computing device 20 is used to login the LBS system 10″ and the position information stored in the account database 19 when the user tries to login the LBS system 10″ with the account. Also in this example, the account will be allowed to login the LBS system 10″ if the difference between the current position information of the first computing device 20 and the registered position information stored in the account database 19 is smaller or equal to a first difference limitation (e.g., the maximum difference or distance between coordinates of the two position information that allowable to login the LBS system 10″).

In another example, the management module 12 may be configured to compare (perhaps by the help of the registration/login module 17) position information of the first computing device 20 when the first computing device 20 sends product information related to the registered position information stored in the account database 19 (i.e., when the management module 12 receives the product information). A product page related to the product information will be generated if the difference between the two position information is smaller or equal to a second difference limitation (e.g., the maximum difference or distance between coordinates of the two position information that the position information will be considered as being sent by the user who owns the account or knows the registered position information of the account).

Similarly, cheating about online shopping may happen when a criminal cracks a seller's account, pretends to be the seller of a product sold by the seller, and deliberately answering a question about the product online to lead a customer (who asks the question) to transfer his/her money to a wrong account. To prevent this fault, the communication module 14 may be configured to compare (perhaps by the help of the registration/login module 17) position information of the first computing device 20 when the first computing device 20 is used to send the answer with the registered position information stored in the account database 19 when the communication module 14 receives the answer about the question. The answer will be considered as valid if the difference between the two position information is smaller or equal to a third difference limitation (e.g., the maximum difference or distance between coordinates of the two position information that the position information of the first computing device 20 may still be recognized as being used by the user or to send the answer when the user grants).

Those skilled in the art can easily understand that the user who owns/registers the account may use other computing device (other than the one who uses to register the account) to login the LBS system 10″, generate a product page or answer the question. If the current position information related to the location where his/her uses the other computing device to login the LBS system 10″ is within a range (e.g., points within the range are all different from the registered position information with a difference less than or equal to the first or the second difference limitation) near the registered position information, the login will still be successful, corresponding product page will still be generated or the answer will still be valid, respectively.

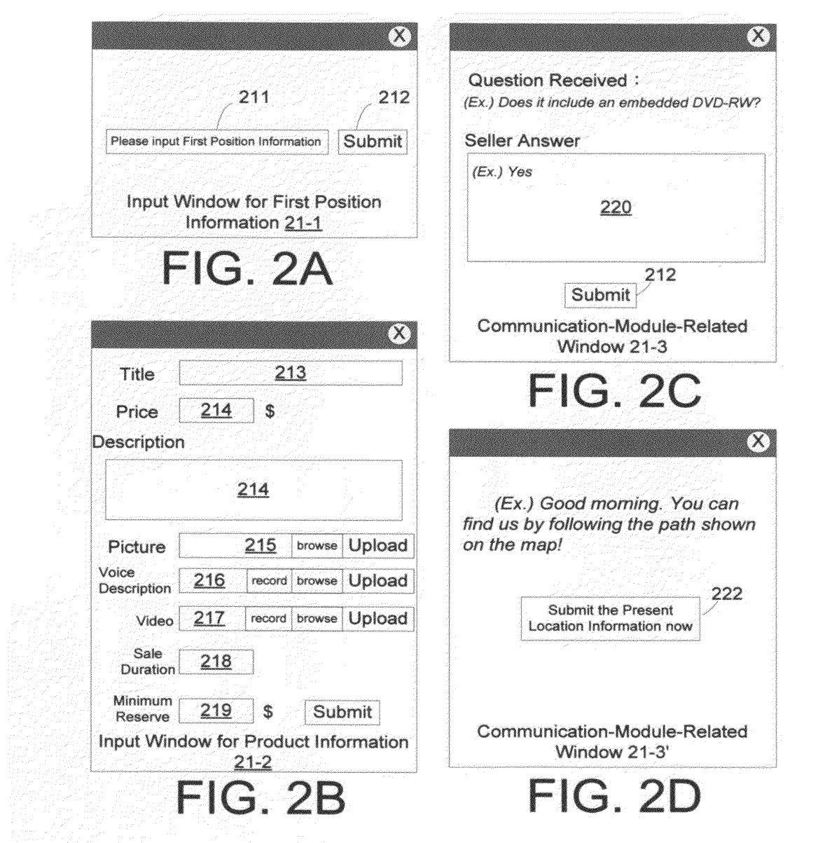

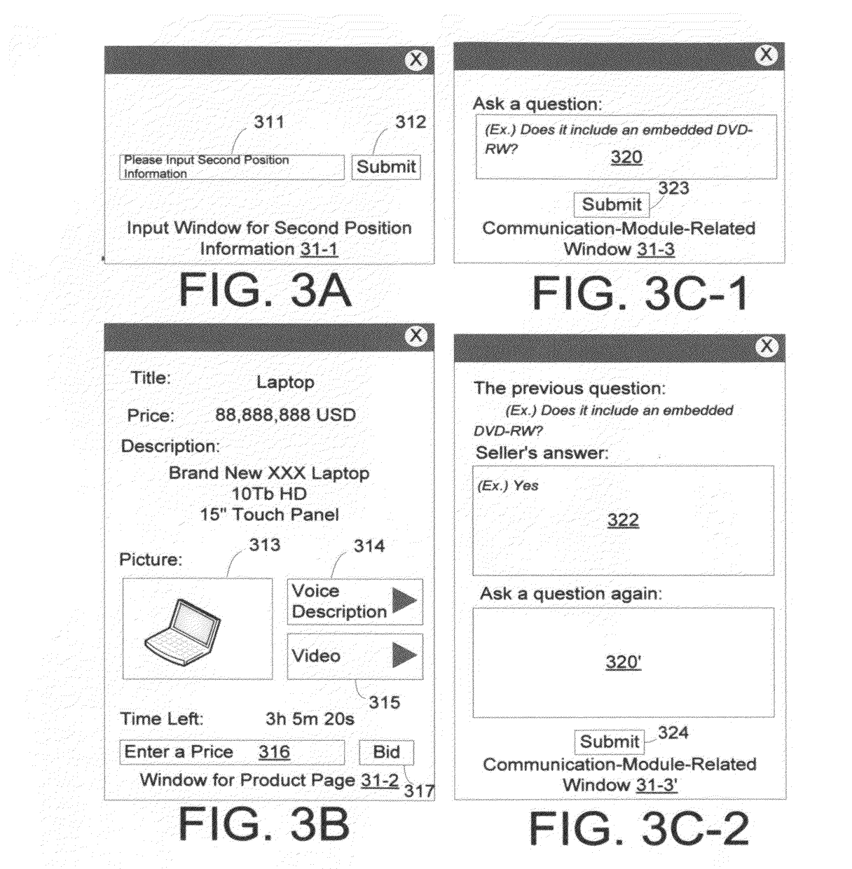

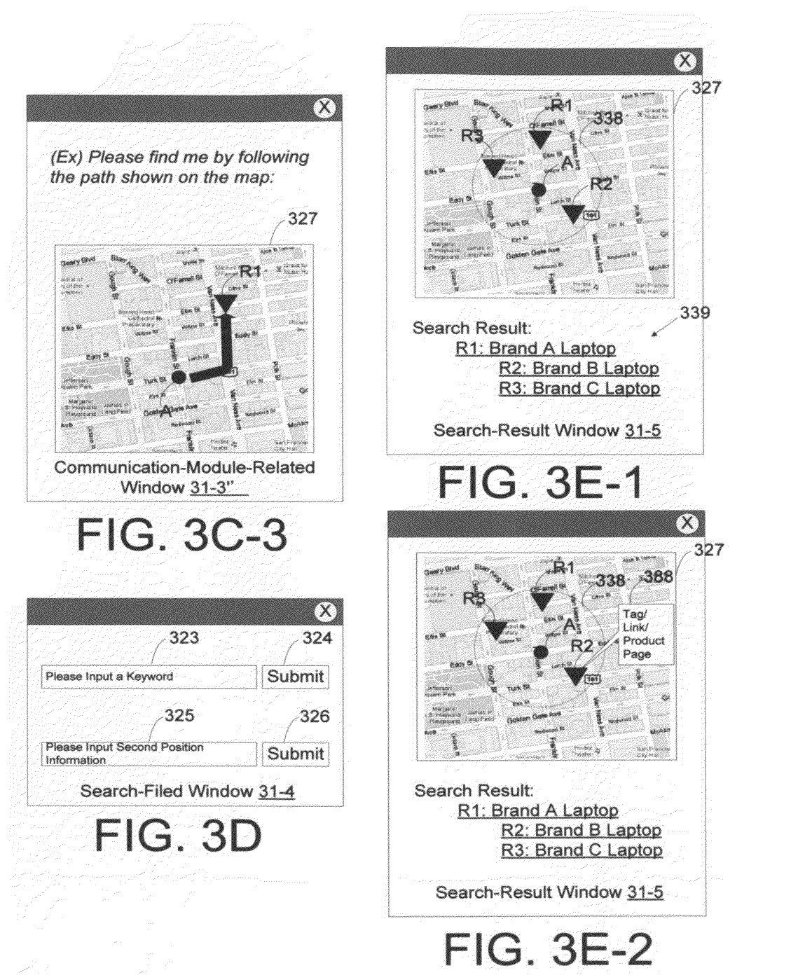

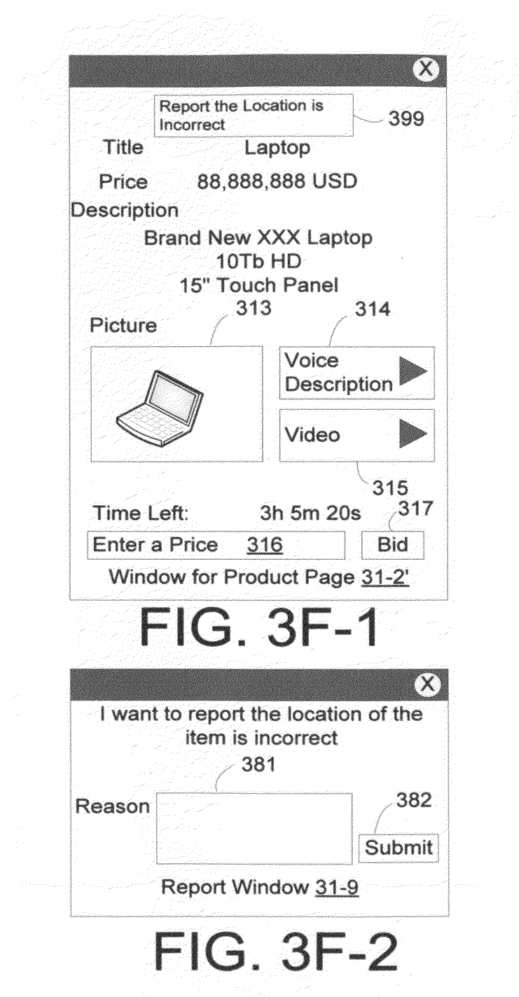

Exemplary windows related to or coupled with the aforementioned modules that could be shown on the screen 21 or 31 may be described and illustrated hereafter with reference to FIGS. 2A to 3F-2. Those skilled in the art can easily understand that these windows may only be examples for explaining some embodiments of the present invention, but should not be the limitation of the scope of the present invention.

FIG. 2A is a diagram illustrating the input window 21-1 according to an example of the present invention. Referring to FIG. 2A, the input window 21-1 may include an input field 211 for a user to enter/input first position information and a submit button 212 for the user to submit the first position information he/she enters to the LBS system 10. In one example, the user may enter his/her address or the address of his/her current location, a name of an attraction or a landmark (or a famous place) as his/her first position information and send the first position information to the position module 11 after clicking the submit button 212.

FIG. 2B is a diagram illustrating the input window 21-2 according to another example of the present invention. Referring to FIG. 2B, the input window 21-2 may include a title field 213 and a price field 214, wherein title field 213 may be configured to enter the title of the product page 16a and the price field 214 may be configured to enter the price of the product. In one example, the price field 214 may be configured to enter a starting price (a starting bid) of the product for customer to make an offer or place a bid having a price higher than the starting price. In another example, the price field 214 may be configured to enter the buy-it-directly price of the product.

Moreover, the input window 21-2 may include a description field 221 configured to enter the description of the product. The input window 21-2 may also include a figure-file-path field 215 for the user (the seller) to enter an archive path directing to a figure file including the image (picture or drawing) of the product. The user may enter the archive path directed to the figure file, or use the browsing button (not numbered) to look for the archive path of the figure file. After clicking the upload button (not numbered), the figure file will be uploaded to the LBS system 10.

Similarly, input window for the product information 21-2 may further include a voice-description-file-path field 216 or a video-file-path field 217 for uploading the files about the voice description or the video of the product, respectively. Moreover, if the first computing device 20 is equipped with a microphone, a camera or a video camera, or coupled with a microphone, a camera or a video camera, the seller may be able to take a picture or record a voice description or a video about the product directly (e.g., by clicking the record button to begin to record the voice description or the video).

Moreover, the input window 21-2 may include a sale-duration field 218 or a minimum-reserve field 219 for the seller to setup the sale duration or the minimum reserve, respectively. Moreover, all the aforementioned settings or files related to the input window 21-2 will be uploaded to the management module 12 after a submit button (not number) in the input window 21-2 is clicked.

FIG. 2C is a diagram illustrating the communication-module-related window 21-3 according to an example of the present invention. Referring to FIG. 2C, the communication-module-related window 21-3 may show the question received by the communication module 14 (in this example, the question is “Does it include an embedded DVD-RW?”). The communication-module-related window 21-3 may provide a message input field 220 for the seller to enter his/her response/answer the question about the product (in this example, the response/answer to the question is “Yes”). The response/answer will be sent to the user (the customer) who asks the question about the product by the help of the communication module 14 after the submit button 212 is clicked. In another example, the message input field 220 may be configured to receive characters or voice (e.g., turn on a microphone or a recorder of the first computing device 20 to record the seller's oral answer).

FIG. 2D is a diagram illustrating a communication-module-related window 21-3′ according to another example of the present invention. Referring to FIG. 2D, a seller may be able to send his/her current position information to a customer by clicking a button 222 to submit the current location information. In one example, if the customer receives the seller's position information, a route corresponding to a path from the location related to current position information of the customer to the location related to the seller's current position information may be shown in a map 327 of a communication-module-related window 31-3″ (see FIG. 3C-3).

FIG. 3A is a diagram illustrating the input window 31-1 according to an example of the present invention. Referring to FIG. 3A, the input window 31-1 may include an input field 311 for the user to enter the second position information and a submit button 312 for submitting the second position information after entering. Similarly, the user may enter his/her address or the address of his/her current location, a name of an attraction or a landmark (or a famous place) as his/her first position information and send the first position information to the position module 11 after clicking the submit button 312.

FIG. 3B is a diagram illustrating the window 31-2 for showing the product page 16a according to an example of the present invention. Referring to FIG. 3B, the window 31-2 may show a product page (e.g., the product page 16a) including at least one of the title (e.g., “Laptop”), the price (e.g., “88,888,888 USD”), the description (e.g., “Brand New XXX Laptop,” “10Tb HD” and “15” Touch Panel”) or the picture or the sale duration of the product (e.g., “Time Left: 3 h 5 m 20 s”). In one example, the window 31-2 may also provide a voice-description play button 314 or a video play button 315 for the user (the customer) to click and play the voice description or the video of the product, respectively.

Moreover, the window 31-2 may further include a bid field 316, the user (buyer) may be able to place a bid or make an offer to the product by entering a price into the bid field 316, and submit the bid or the offer after clicking the bid button 317 to the management module 12. In one example, when the offer price of the bid is larger than or equal to the minimum reserve, the bid module 12-1 will determine that the bid is valid. In another example, when the sale duration expires, the bid module 12-1 will consider the bid (perhaps from a plurality of bids placed for buying the product) having highest offer price to be the winning bid, and a user who places the winning bid will win the product by paying the offer price of the winning bid.

FIG. 3C-1 is a diagram illustrating the communication-module-related window 31-3 according to an example of the present invention. A communication process of the window 31-3 may be similar to the communication process of the window 21-3 described and illustrated with reference to FIG. 2C.

FIG. 3C-2 is a diagram illustrating a communication-module-related window 31-3′ according to another example of the present invention. Similarly, a communication process of the window 31-3 may be similar to the communication process of the window 21-3 described and illustrated with reference to FIG. 2C.

FIG. 3C-3 is a diagram illustrating the communication-module-related window 31-3″ according to other example of the present invention. Referring to FIG. 2D again, after receiving the seller's current location information (which is sent after the seller clicks the button 222 to submit it), the second computing device 30 will open the communication-module-related window 31-3″ after receiving the seller's current position information, and the route corresponding to the path from the location related to the current position information of the second computing device 30 (i.e., the customer's current position information) to the location related to the seller's current position information may be shown in the map 327 of a communication-module-related window 31-3″.

FIG. 3D is a diagram illustrating the search-field window 31-4 according to an example of the present invention. Referring to FIG. 3D, the search-field window 31-4 may include the search field 323 and a submit button 324, wherein the input field 323 may be configured for the user to enter a keyword and submit the keyword to the search module 15 by clicking the submit button 324.

In one example, if the second computing device 30 does not include the GPS module, a second-position-information-input field 325 and a submit button 326 will also be provided in the search-field window 31-4, wherein the second-position-information-input field 325 may be used to enter the second position information and send it to the search module 15 after the submit button 326 is clicked.

In this example, the search module 15 may be configured to search at least one of product information, product pages, tags or icons with locations locates with in a range (perhaps a predetermined range, see a range 338 in FIG. 3E-1) near the location on the map corresponding to the second position information or centered by the location on the map corresponding to the second position information to find product information, a product page or an icon related to the keyword after receiving the keyword and the second position information.

FIG. 3E-1 is a diagram illustrating the search-result window 31-4 according to another example of the present invention. Referring to FIG. 3E-1, the map information module 13 may be configured to mark locations related to the search result on the map 327 with icons R1, R2 or R3. In one example, the search-result window 31-4 may show the locations related to the search result within the range 338 (by marking the locations with icons such as the icons R1, R2 or R3 in this example) centered by a location A (i.e., the location of the second computing device 30 in this example). In another example, the search result may also be described below (e.g., “R2: Brand B Laptop,” etc.).

When the icon R1 (or R2 or R3) is selected, a tag 388 associated with the icon R1 may be shown for example. The tag 388 may include at least one of the product page 16a or the link (or hyperlink) that can be used to link to the product page, as shown in FIG. 3E-2. In one example, the tag 388 may further include at least one of the title, the price, the description, the picture, the voice-description-play button or the video-play button related to the product page 16a.

FIG. 3F-1 is a diagram illustrating a product-page window 31-2′ according to another example of the present invention. Referring to FIG. 3F-1, the product-page window 31-2′ may be similar to the product-page window 31-2 described and illustrated with reference to FIG. 3B, except that a report button 399 may also be provided in the product-page window 31-2′. The report button 399 may be used in a situation as follows:

One day, Joseph wants to buy a brand B laptop. He uses his second computing device 30 to open the search-field window 31-4 and enter a keyword “XXX laptop”. Later, the search-result window 31-5 shows that there is a seller selling the brand B laptop at the location marked as the icon R2 around his location A on the map 327. Then, he goes for the seller as indicated on the map 327. However, he finds that actually there is no seller selling the brand B laptop at the location in the real world. Then he may reopen the window 31-2′ again and click the report button 399 to indicate that there is no such seller at the location in the world (the location related to the product page or the icon R2 is incorrect).

In another example, after the report button 399 is clicked, the report window 31-9 may be opened on the screen 31. The report window 31-9 may include a reason field 381 for entering the reason why a product page is reported, as shown in FIG. 3F-2. The report including the reason will be sent after a submit button 382 is clicked. In other example, the reason may be reviewed by an administrator of the LBS system 10.

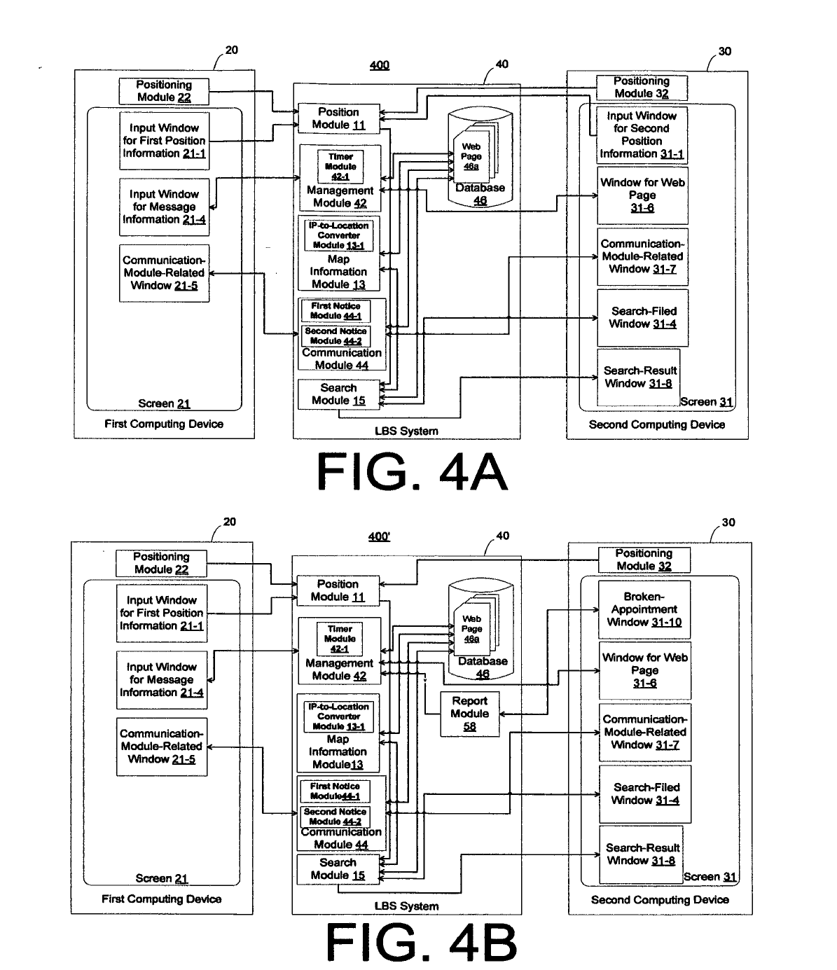

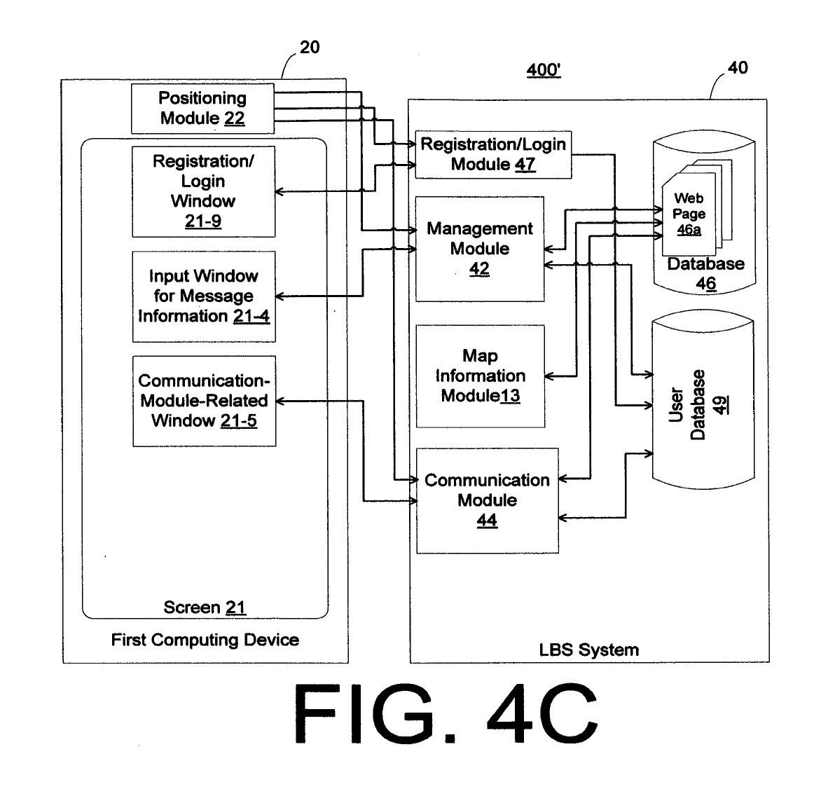

FIG. 4A is a block diagram illustrating an LBS system 40 according to an example of the present invention. Referring to FIG. 4A, the LBS system 40 may be similar to the LBS system 10 described and illustrated with reference to FIG. 1A, except that a management module 42 and a communication module 44 of the LBS system 40 may be different from the management module 12 and the communication module 14.

The management module 42 may be configured to receive message information (e.g., a message a user wants to leave) and a value of an expiration time, and generate a web page 46a to show the message information. In one example, the message information may include at least one of a title, a description, a picture, a voice description or a video. The programming codes or file(s) related to the web page 46a may be stored in a database 46.

In one example, the management module 42 may further include a timer module 42-1. The timer module 42-1 may be configured to count the time elapsing after the web page 46a is generated, and compare the time and the value of the expiration time to decide if the web page 46a or the message information shown on the web page 46a should still be shown or be marked as valid.

Moreover, communication module 44 may further include a first notice module 44-1 and a second notice module 44-2, wherein first notice module 44-1 may be configured to send a first notice if the communication module 44 receives a first message about the message information (e.g., another user leave another message based on the message information shown on the web page 46a to the user), and second notice module 44-2 may be configured to send a second notice if the communication module receive 44 receives a second message (e.g., the user who generates the web page 46a leaves a new message to response the first message) In one example, at least one of the first notice module 44-1 or the second notice module 44-2 may include at least one of a question and answer (Q&A) module, an e-mail module or an instant messenger module (instant messenger).

Similarly, the screen 21 may be capable of showing a input window 21-4 coupled with the management module 42 for the user to input the message information, except that the screen 21 may show a input window 21-1 coupled with the position module 11 for the user to input his/her address (e.g., of his/her current location). Moreover, the screen 21 may show a communication-module-related window 21-5 coupled with the communication module 44 for the user to receive the first message or input the second message.

Similarly, the screen 31 may be capable of showing a window 31-6 for the user of the second computing device 30 to get/browse the message information, except that the screen 31 may show a input window 31-1 coupled with the position module 11 for the user to input his/her second position information (e.g., the address he/her locates on now). Moreover, may show a communication-module-related window 31-3 coupled with the communication module 44 for the user to send the first message or receive the second message.

Similarly screen 31 may show a search-field window 31-4 and a search-result window 31-8 coupled with the search module 15, to receive a keyword and to show a search result according to the keyword and the second position information, separately.

Those skilled in the art can also understand that the search-field window 31-4 and the search-result window 31-8 may be shown with a single window or with two different windows.

FIG. 4B is a block diagram illustrating an LBS system 40′ according to another example of the present invention. Referring to FIG. 4B, the LBS system 40′ may be similar to the LBS system 40 described and illustrated with reference to FIG. 4A, except that the LBS system 40′ may further include a report module 58 and may cause the screen 31 of the second computing device 30 to show a report window 31-10 coupled with the report module 58.

Because that when a user finds a web page including message information he/she is interested through the LBS system 40′ and tries to go to the location on the map related to the web page to see the user who generates the web page, if the location of the web page is incorrect, or if the user who generates the web page not show up on the location, it may waste his/her time (on a fool's errand). Once the user finds this situation, there may be desirable to have a mechanism for him/her to warn other users not to be cheated by the web page as him/her. To this end, the report module 58 of the LBS system 40′ may provide the report mechanism. Once the user finds he/she is cheated or the user who generates the web page breaks their appointment, he/she may open a broken-appointment window 31-10 and push (press or click) a report button 588 in the window to send a report to the report module 58 for indicting the situation. In one example, there may be a field for him/her to enter the reason why he/she reports the web page and the reason will be send with the report to the report module 58. Then, the management module 42 may execute at least one of showing the web page is incorrect (or the location of it is incorrect), cancelling the web page, withdrawing the web page or making other user(s) cannot find what he/she wants at the location of the web page.

However, if the management module 42 takes the above-mentioned action(s) to the product page 16a only based on a single user's report, it may be unfair since the user who reports may make a mistake or deliberately try this way to cause the web page to be cancelled. In another example, the report module 58 may be configured to count the number of reports generated by different users about the web page, and the report module 58 will cause the management module 42 to execute the at least one of showing the web page is incorrect, cancelling the web page or withdrawing the web page if the number of reports achieves or exceeds a first limited number. Note that in some examples the first limited number could also be set as “1”.

Similarly, in order to ensure the effectiveness of the report, to location-based service field, the LBS system 40′ may follow the rule—“to see is to believe”. Therefore, the report module 58 may be configured to compare position information of the second computing device the use uses to generate the report with the first position information related to the location of the web page, and the report will be determined to be valid only if the difference between the two position information is smaller or equal to a difference limitation, which means when generating the report, only if the user's location is really close to the location of the web page his/her report will be considered as valid.

Moreover, in still another example, the report module 58 may be configured to count the number of the abovementioned valid reports generated by different users to the web page, and the report module 58 will cause the management module 42 to execute the at least one of showing the web page is incorrect, cancelling the web page or withdrawing the web page if the number of valid reports achieves or exceeds a second limited number. Note that in some examples the second limited number could also be set as “1”.

FIG. 4C is a block diagram illustrating an LBS system 40″ according to still another example of the present invention. Referring to FIG. 4C, the search module 15 and some windows on the screen 21 or 31 that related to the modules 11 and 15 are not shown for simplifying the illustration. However, the LBS system 40″ may be similar to the LBS system 40 or 40′ described and illustrated with reference to FIG. 4A or 4B, except that the LBS system 40″ may further include a registration/login module 47. The registration/login module 47 may be coupled with a user database 49. Also, the registration/login module 47 may cause the screen 21 of the first computing device 20 to show a registration/login window 21-9 coupled with the registration/login module 47.

The registration/login module 47 may be configured to record position information related to an account into the user database 49 when the account is registered by the user who uses the first computing device 20. In this example, the registration/login module 47 may be configured to receive data including the account, a password related to the account or other personal details entered by the user who wants to register the account into the LBS system 40″ through the registration/login window 21-9 coupled with the registration/login module 47. When registering the account, position information related to the user may also be registered and stored in the user database 49. In one example, the registered position information may come from an address entered in the registration/login window 21-9 by the user when registering, and the registration/login module 47 may look up position information corresponding to the address entered as the registered position information. In another example, the registered position information may come from position information received by the positioning module 22 in the first computing device 20 coupled with the LBS system 40″ when the user registered his/her account (i.e., the position information of the first computing device 20 when it is used by the user to register the account).

Moreover, the positioning module 22 may be configured to send currently received position information when the user tries to use the first computing device 20 to login the LBS system 40″. In this example, the registration/login module 47 may be configured to compare the current position information of the first computing device 20 when the first computing device 20 is used to login the LBS system 40″ and the position information stored in the user database 49 i.e., when the user tries to login the LBS system 40″ with the account. Also in this example, the account will be allowed to login the LBS system 40″ if the difference between the current position information of the first computing device 20 and the registered position information stored in the user database 49 is smaller or equal to a third difference limitation (e.g., the maximum difference or distance between coordinates of the two position information that allowable to login the LBS system 40″).

In another example, the management module 42 may be configured to compare (perhaps by the help of the registration/login module 47) position information of the first computing device 20 when the first computing device 20 sends message information related to the registered position information stored in the user database 49 (i.e., when the management module 42 receives the message information). A web page related to the message information will be generated if the difference between the two position information is smaller or equal to a fourth difference limitation (e.g., the maximum difference or distance between coordinates of the two position information that the message information will be considered as being sent by the user who owns the account or knows the registered position information of the account).

Moreover, in one example, the communication module 44 may be configured to compare (perhaps by the help of the registration/login module 47) position information of the first computing device 20 (or the second computing device 30) when the first computing device 20 (or the second computing device 30) is used to send a message (or message information) with the registered position information. The message (or message information) will be considered as valid if the difference between the two position information is smaller or equal to a fourth difference limitation.

Those skilled in the art can easily understand that the user who owns/registers the account may use other computing device (other than the one who uses to register the account) to login the LBS system 40″, generate a web page or send a message. If the current position information related to the location where his/her uses the other computing device to login the LBS system 10″ is within a range (e.g., points within the range are all different from the registered position information with a difference less than or equal to the first or the second difference limitation) near the registered position information, the login will still be successful, corresponding product page will still be generated or the message will still be valid, respectively.

Exemplary windows related to or coupled with the aforementioned modules that could be shown on the screen 21 or 31 may be described and illustrated hereafter with reference to FIGS. 5A to 6D-2. Those skilled in the art can easily understand that these windows may only be examples related to some embodiments of the present invention, but should not be the limitation of the scope of the present invention.

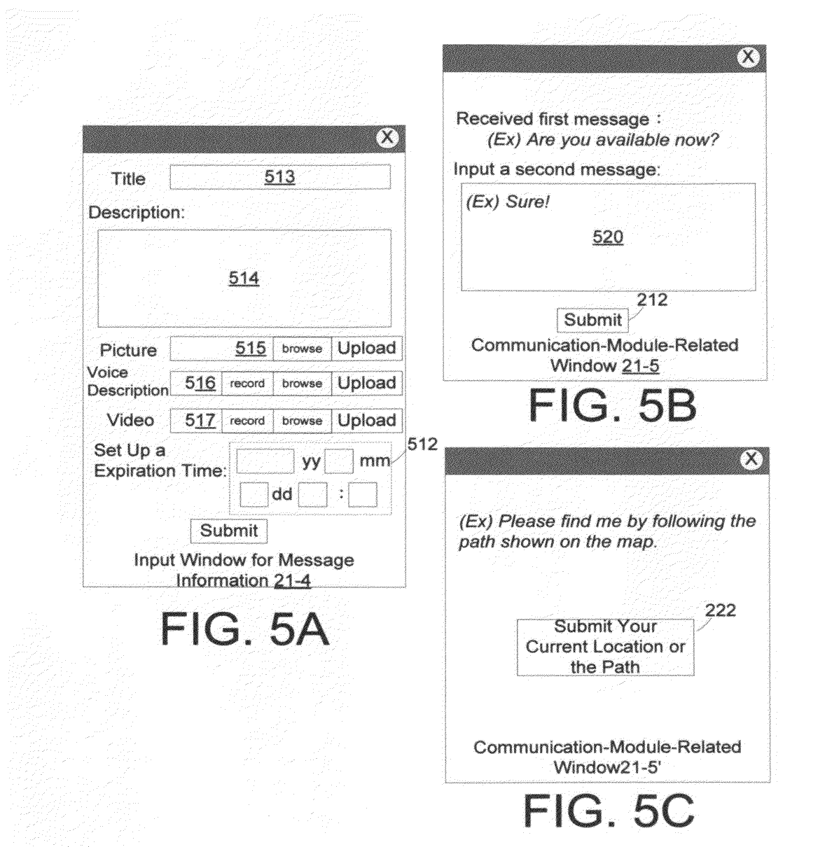

FIG. 5A is a diagram illustrating the input window 21-4 for the message information according to an example of the present invention. Referring to FIG. 5A, the input window 21-4 may be similar to the input window 21-2 described and illustrated with reference to FIG. 2B, except that the input window 21-4 may include fields 512 for setting up the expiration time (i.e., the web page will be valid until the expiration time), instead of fields 218 and 219 for setting the sale duration and the minimum reserve.

FIG. 5B is a diagram illustrating the communication-module-related window 21-5 according to an example of the present invention. Referring to FIG. 5B, the communication-module-related window 21-5 may be similar to the communication-module-related window 21-3 described and illustrated with reference to FIG. 2C.

FIG. 5C is a diagram illustrating the communication-module-related window 21-5′ according to an example of the present invention. Referring to FIG. 5C, the communication-module-related window 21-5′ may be similar to the communication-module-related window 21-3′ described and illustrated with reference to FIG. 2D.

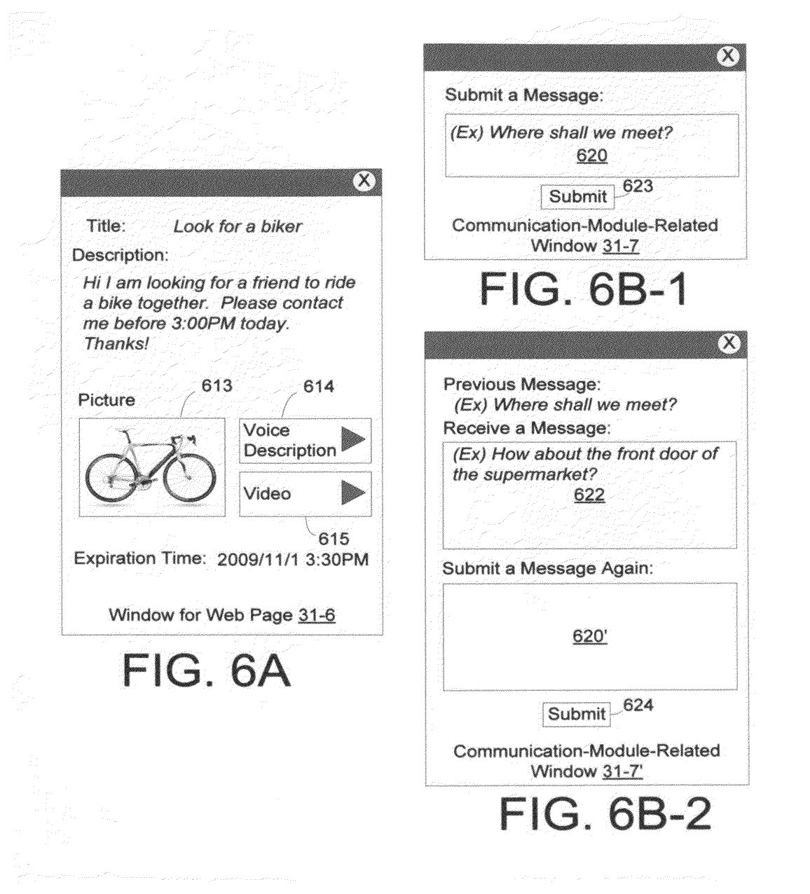

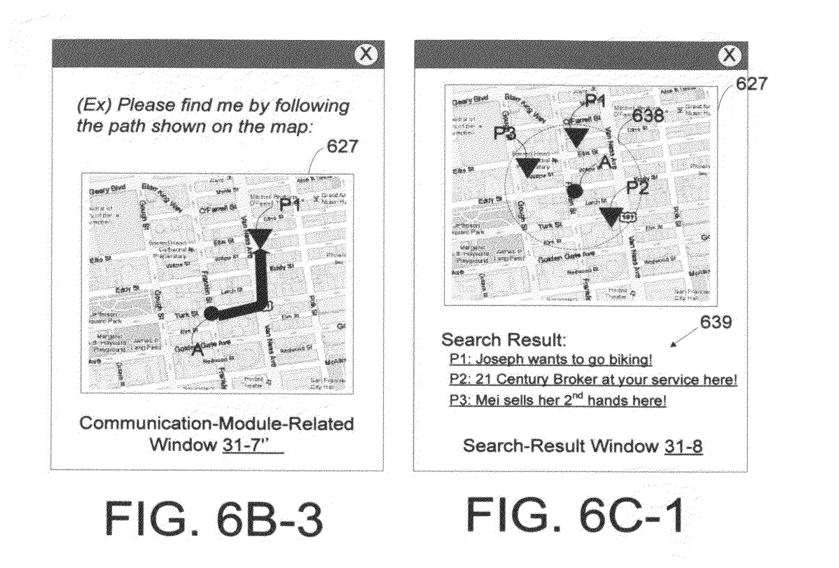

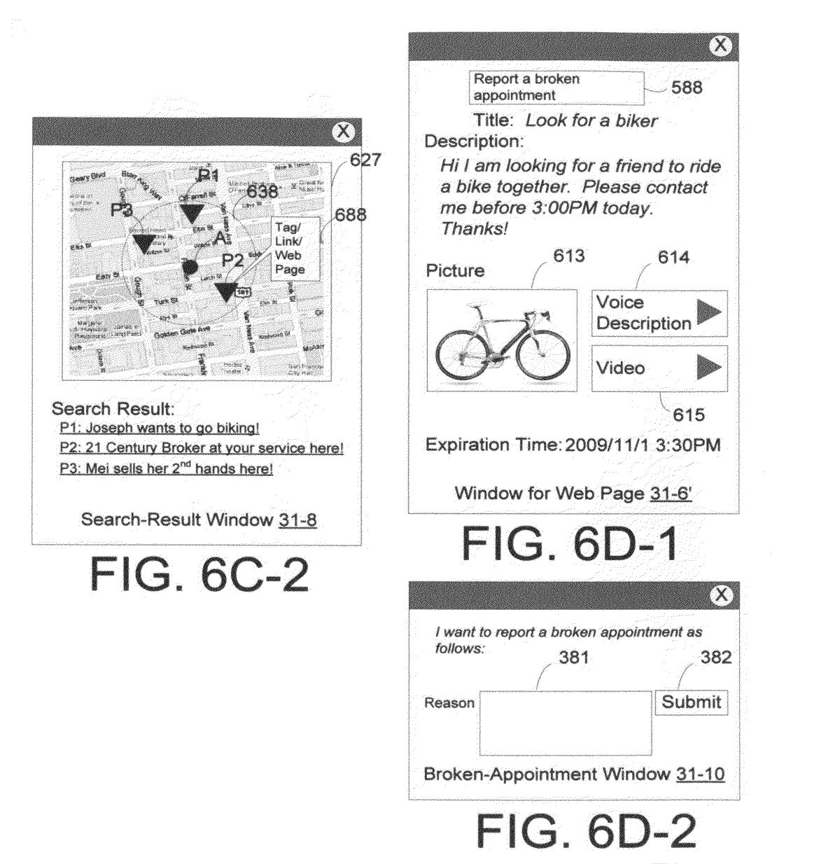

FIG. 6A is a diagram illustrating the window 31-6 according to an example of the present invention. Referring to FIG. 6A, the window 31-6 may show a web page including at least one of the title (e.g., “Look for a biker”), the description (e.g., “Hi I am looking for a friend to ride a bike together . . . ”), or the picture or the expiration time (e.g., “2009/11/1 3:30 PM”). In this example, the window 31-6 may be similar to the window 31-2 described and illustrated with reference to FIG. 3D, except that the fields 218 and 219 are not shown/provided in the window.

FIG. 6B-1 is a diagram illustrating the communication-module-related window 31-7 according to an example of the present invention, and FIG. 6B-2 is a diagram illustrating a communication-module-related window 31-7′ according to an example of the present invention. Referring to FIG. 6B-1 and FIG. 6B-2, the communication-module-related window 31-7 or 31-7′ may be similar to the communication-module-related window 31-3 or 31-3′ described and illustrated with reference to FIG. 3C-1 or FIG. 3C-2, respectively.

FIG. 6B-3 is a diagram illustrating a communication-module-related window 31-7″ according to another example of the present invention. Referring to FIG. 6B-3, the communication-module-related window 31-7″ may be similar to the communication-module-related window 31-3″ described and illustrated with reference to FIG. 3C-3.

FIG. 6C-1 is a diagram illustrating the search-result 31-8 window according to another example of the present invention. Referring to FIG. 6C-1, the map information module 13 of the LBS system 40 may be configured to mark locations related to the search result on the map 627, for example, with icons P1, P2 or P3. In one example, the search-result window 31-8 may show the locations (by marking the locations with icons such as the icons P1, P2 or P3 in this example) related to the search result within the range 638 centered by a location A (i.e., the location of the second computing device 30 in this example). In another example, the search result may also be described below (e.g., “P1: Joseph wants to go biking,” etc.).

When the icon P1 (or P2 or P3) is selected, a tag 688 associated with the icon P1 may be shown for example. The tag 688 may include at least one of the web page 46a or the link (or hyperlink) that can be used to link to the web page 46a, as shown in FIG. 6C-2. In one example, the tag 688 may further include at least one of the title, the price, the description, the picture, the voice-description-play button or the video-play button related to the web page 46a.

FIG. 6D-1 is a diagram illustrating the window 31-6′ according to another example of the present invention. Referring to FIG. 6D-1, a report button 588 of the window 31-6′ may be similar to the report button 399 of the window 31-2′ described and illustrated with reference to FIG. 3F-1.

FIG. 6D-2 is a diagram illustrating the broken-appointment window 31-10 according to an example of the present invention. Referring to FIG. 6D-2, the broken-appointment window 31-10 may be similar to the report window 31-9 described and illustrated with reference to FIG. 3F-2. In this example, the report including the reason will be sent after a submit button 382 is clicked. In other example, the reason may be reviewed by an administrator of the LBS system 40.

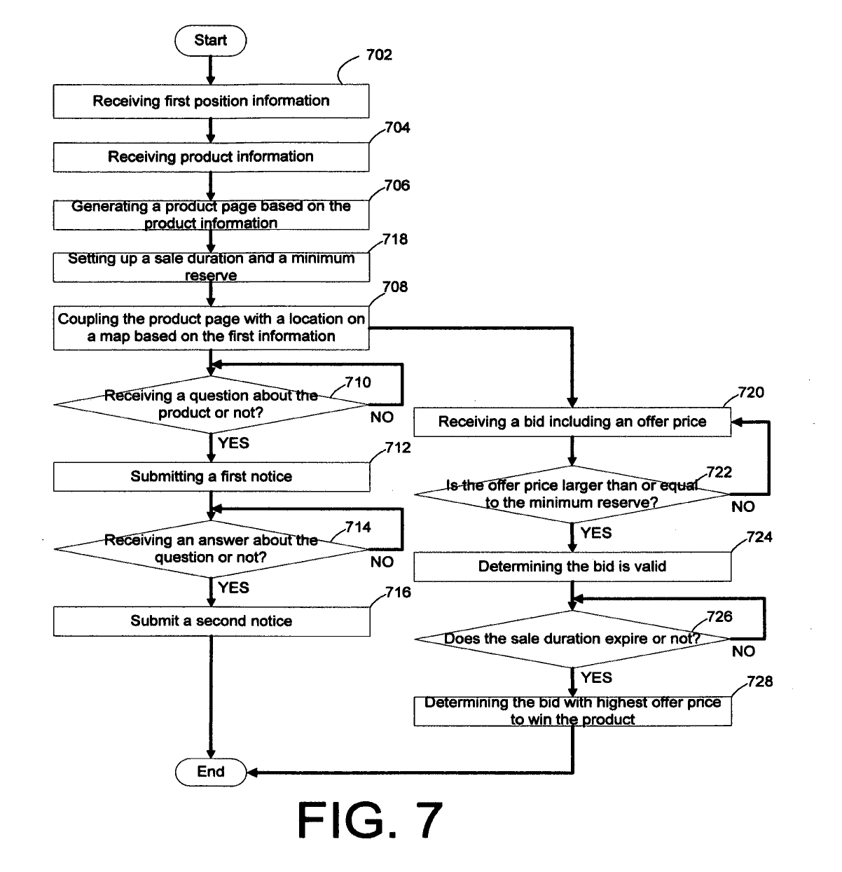

FIG. 7 is a flowchart illustrating a method of providing a location-based service according to an example of the present invention. Referring to FIG. 7, in step 702, the position module 11 may receive the first position information through the input window 21-2 or the positioning module 22. In step 704, the management module 12 may receive the product information, wherein the product information may include at least one of the title, the price, the description, the picture, the voice description or the video of the product. In step 706, the management module 12 may generate the product page 16a based on the product information, wherein the product page 16a may include at least one of the title, the price, the description, the picture, the voice description or the video of the product. In step 708, the map information module 13 may couple the product page with the location on the map based on the first position information.

Furthermore, in step 710, the communication module 14 may determine/identify if it receives the question about the product from the communication-module-related window 31-3. If yes, the communication module 14 will send a first notice to inform the seller of the product, as shown in step 712. In step 714, the communication module 14 may also determine/identify if it receives the answer about the question from the communication-module-related window 21-3. If yes, the communication module 14 may send a second notice to inform the user who asks the question.

In one example, in step 708, the map information module 13 may mark the location of the product page 16a with the icon shown on the map, wherein at least one of the tag, the product page 16a or the link linked to the product page 16a will be shown when the icon is clicked or selected. Moreover, the tag may include or be related to at least one of the title, the price, the description, the picture, the voice description or the video of the product.

In other example, in step 708, the IP-to-location converter module 13-1 may convert the IP address related to the product information into the location shown on the map.

In another example, the management module 12 may receive a sale duration setting and/or a minimum reserve setting to set the sale duration and/or the minimum reserve of the product on the product page 16a in step 718.

In step 720, the management module 12 may receive a bid from the product-page window 31-2, wherein the bid may include an offer.

In step 722, the management module 12 may identify if the offer is larger than or equal to the minimum reserve. If the offer is larger than or equal to the minimum reserve, the bid will be identified as effective (or valid) in step 724.

In step 726, the management module 12 may determine if the sale duration expires (or ends) or not. When the sale duration expires (or ends), the bid including highest offer will be identified as the winner of the product in step 728.

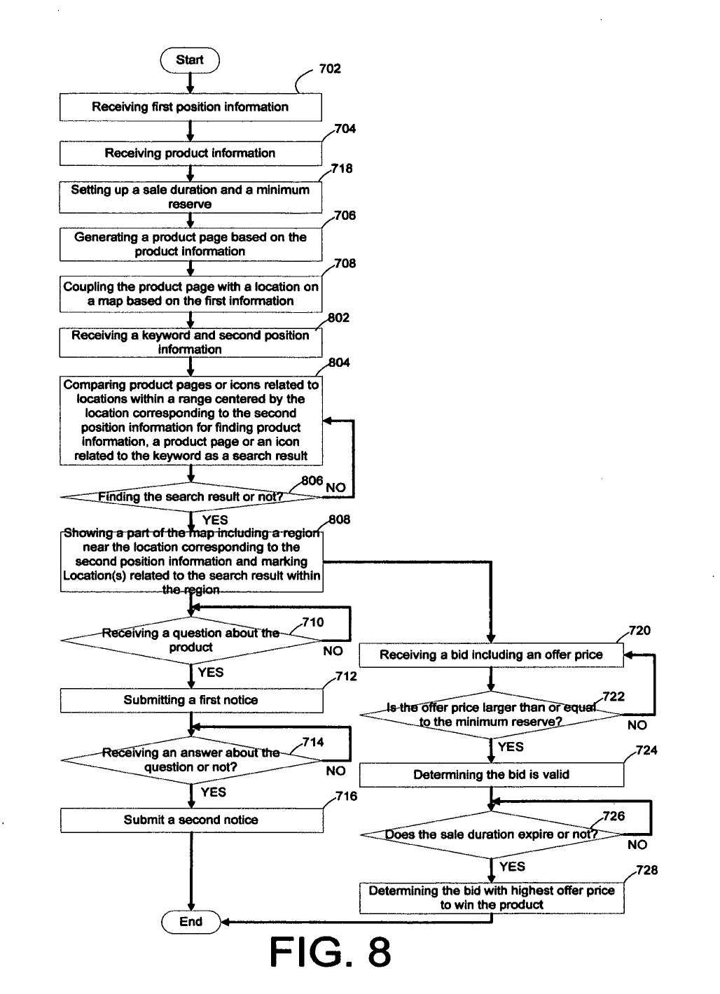

FIG. 8 is a flowchart illustrating a method of providing a location-based service according to another example of the present invention. Referring to FIG. 8, except step 802, 804, 806 and/or 808 the location-based service method described and illustrated in connection with FIG. 8 may be similar to the method described and illustrated with reference to FIG. 7.

In step 802, the search module 15 may receive a keyword from the search-field window 31-4 and second position information, wherein the second position information may be inputted by a user who wants to look for product information related to the keyword and around him. Further, the second position information may be entered by the user through the window 31-1, or sent by the positioning module 32 to the position module 11. In one example, the second position information may include at least one of latitude and longitude, a name of an attraction or a landmark, an address or the IP address of the device sending the keyword.

In step 804, the search module 15 may search the product pages, the product information, the tags or the icons related to locations within the range centered by the location corresponding to the second position information or near the location on the map corresponding to the second position information to find the product information, the product page, the tag or the icon related to the keyword as the search result.

In step 806, the search module 15 may identify if the search result is found. If the search result is found, the map information module 15 may show the range and mark those related to the search result on the map in the search-result window 31-5 in step 808.

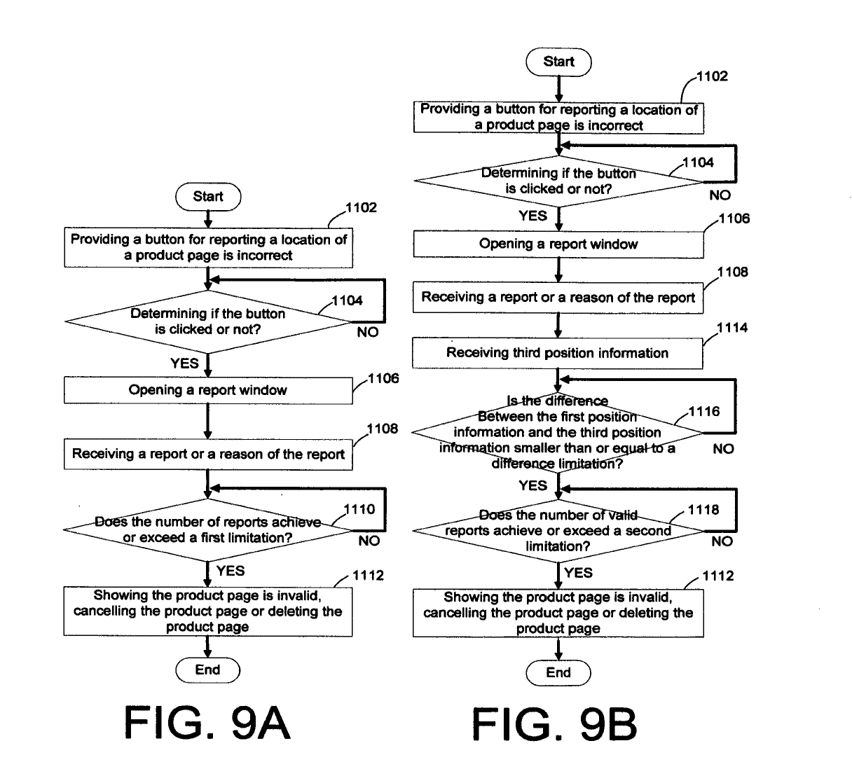

FIG. 9A is a flowchart illustrating a method of providing a location-based service according to still another example of the present invention. Referring to FIG. 9A, in step 1102, the management module 12 may generate the product page 16a according to the product information if it receives the product information. When generating the product page 16a, a report button 399 may be provided together with the report product page 16a for reporting then location of the product (or related to the product page 16a) is incorrect. That is, both the product page 16a and the report button 399 will be shown in the window 31-2. The report button 399 may be coupled to the report module 18 and configured to send a report (e.g., a single message to indicate the location is incorrect or together with the reason why the product page 16a is reported) to the report module 18 when the report button 399 is pressed, clicked, touched or selected. In one example, when the report button 399 is clicked or selected, the report window 31-9 will be opened for the user to enter his/her reason about reporting the product page 16a.

In step 1104, the report module 18 may identify if the report button 399 is clicked/selected. If “yes,” which means the user reports the product page 16a, go to step 1110. Otherwise if “No,” remain standby and wait for next time the report button is clicked/selected.

In step 1110, the report module 18 may identify if the number of reports that report the location related to the product page 16a is incorrect is larger than or equal to a number limitation (or a maximum number or an upper bound). If “yes,” go to step 1112. If “No,” keep going to accumulate the number of the reports when receiving a new report. When the number of reports is larger than or equal to a limitation, the report module 18 will cause the management module 12 to execute at least one of showing the product page 16a is invalid (or, showing the location is incorrect), cancelling the product page 16a or withdrawing the product page 16a.

Moreover, in step 1104, if “yes,” then go to step 1106. In step 1106, the report window 31-9 will be opened for the user to generate a report or to enter his/her reason why he/she reports the product page 16a in step 1108.

FIG. 9B is a flowchart illustrating a method of providing a location-based service according to yet another example of the present invention. Referring to FIG. 9B, the location-based service method described and illustrated in connection with FIG. 9B may be similar to the method described and illustrated with reference to FIG. 9A, except that steps 1114, 1116 or 1118 may not be the same.

In step 1114, the report module 18 may receive third position information (e.g., its current latitude and longitude) of the second computing device 30 used to send the report. In step 1116, the report module 18 may check if the difference between the third position information and the first position information is smaller than or equal to the difference limitation. If the difference between the third position information and the first position information is smaller than or equal to the difference limitation (i.e., if “yes” in step 1116), the report will be determined as valid and then go to step 1118.

In step 1118, the report module 18 may count the number of valid reports the product page 16a being reported as its location is incorrect. If the number of valid reports is larger than or equal to the number limitation, the report module 18 will cause the management module 12 to execute at least one of showing the product page 16a is invalid, cancelling the product page 16a or withdrawing the product page 16a.

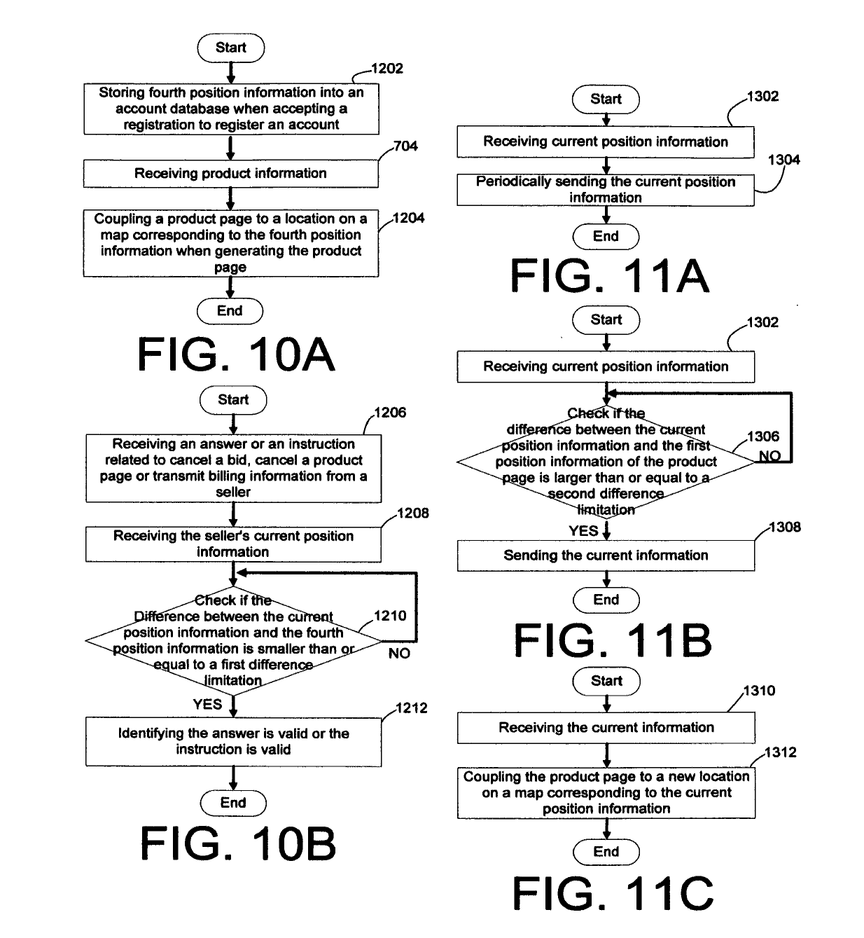

FIG. 10A is a flowchart illustrating a method of providing a location-based service according to still another example of the present invention. Referring to FIG. 10A, in step 1202, when an account is registered, fourth position information of (related to) the account (e.g., related to the location the user of the account wants to be identified as an effective location) may be stored into the account database 19. In one example, the fourth position information of (related to) the account may be entered by the user when registering the account (e.g., to enter the user's location or the location he or she wants to be identified as effective) and stored into the account database 19. In another example, the fourth position information of (related to) the account may be stored as the position information of the first computing device 20 when the first computing device 20 is used to register the account.

In step 1204, the management module 12 may receive the product information. In step 1206, the management module 12 may generate a product page according to the product information and couple a location on the map to the product page based on the fourth position information.

FIG. 10B is a flowchart illustrating a method of providing a location-based service according to yet another example of the present invention. Referring to FIG. 10B, in step 1206, the management module 12 may receive the product information generated by the seller, the answer or the instruction from the seller.

In step 1206, the position module 11 may receive fifth position information related to the location when the seller generates the product information or the instruction (i.e., the location of the first computing device 20 used to generate/send the product information or the instruction).

In step 1210, the management module 12 may compare the fifth position information with the fourth position information stored in the account database 19. When the difference of the two position information is smaller or equal to the difference limitation, go to step 1212. In step 1212, the management module 12 may generate a product page based on the product information, show the answer or execute the instruction.

FIG. 11A is a flowchart illustrating a method of providing a location-based service according to still another example of the present invention. Referring to FIG. 11A, in step 1302, when a user (or a seller) login the LBS system 10″′ with his/her account through the first computing device 20, the positioning module 22 of the first computing device 20 may periodically or continuously receive the current position information of the first computing device 20 from the GPS module. In step 1304, the positioning module 22 may periodically or continuously send the current position information of the first computing device 20 to the position module 11 of the LBS system 10″′.

Those skilled in the art can easily understand that, in the aforementioned method, step 1304 can be changed to send the current position information of the first computing device 20 only if the difference between the current position information and its previous position information is larger than or equal to a difference limitation, but not periodically or continuously. The method is shown in FIG. 11B. Those skilled in the art can easily understand that applying the method described and illustrated with reference to FIG. 11B may consume less power than applying the method described and illustrated with reference to FIG. 11A.

FIG. 11C is a flowchart illustrating a method of providing a location-based service according to still another example of the present invention. Referring to FIG. 11C, in step 1310, the position module 11 of the LBS system 10″′ may receive updated (or current) position information (sent by the positioning module 22) of the first computing device 20 used to login an account, and the management module 12 may couple a product page generated by the account with a location on the map related to the updated position information in step 1312.

In one example, the management module 12 may be configured to couple the product page generated by the account with a location on the map related to the updated position information only if the difference between the updated position information and its previous position information is larger than or equal to a first difference limitation, or cancel the product page if the difference is larger than or equal to a second difference limitation (which means the seller who login the LBS system 10″′ with the account is too far away from his/her original location setting of its product page).

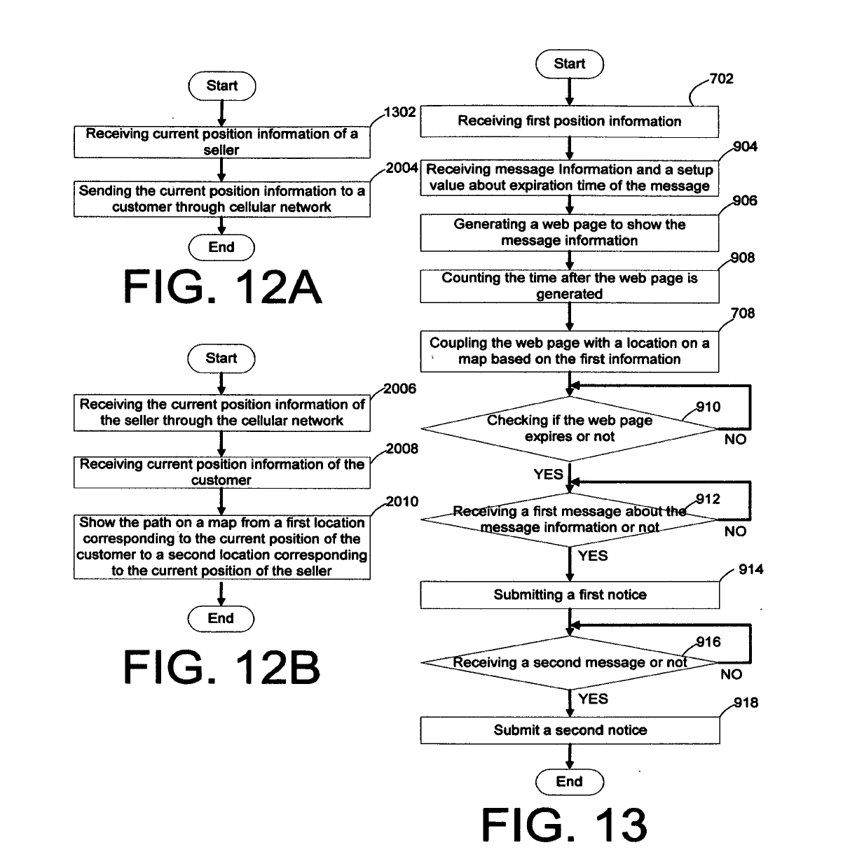

FIG. 12A is a flowchart illustrating a method of providing a location-based service according to still another example of the present invention. Referring to FIG. 12A, after step 1302 as mentioned above, in step 2004, the positioning module 22 may be configured to send the current position information (i.e., related to the seller's current location) to the LBS system 10, and then the LBS system 10 will pass the current position information to the second computing device 30, or directly send the current position information to the user's second computing device 30 through the cellular network (e.g., an SMS including the current position information).

FIG. 12B is a flowchart illustrating a method of providing a location-based service according to yet another example of the present invention. Referring to FIG. 12B, in step 2006, the second computing device 30 will receive the current position information. In step 2008, the GPS module or the positioning module 32 of the second computing device 30 may also receive the current position information of the user. Next, in step 2010, the second computing device 30 may show the map with a reference path from the user's current position information to the seller's current position information on its screen 31.

FIG. 13 is a flowchart illustrating a method of providing a location-based service according to still another example of the present invention, wherein steps 702 and 708 are the same or similar to the steps described and illustrated with reference to FIG. 7. Referring to FIG. 13, in step 904, the management module 42 may receive message information and a value of an expiration time from the input window 21-4.

In step 906, the management module 42 may generate a web page to show the message information. The message information may include at least one of a title, a description, a picture, a voice description or a video. The web page may include at least one of the title, the description, the picture, the voice description or the video.

In step 908, the timer module 42-1 may count the time after the web page is generated.

In step 910, the timer module 42-1 may compare current time and the value of the expiration time to determine if the web page expires or not. If “yes,” go to step 912.

In step 912, the first notice module 44-1 may determine if a first message related to the message information is received. When receiving the first message, the first notice module 44-1 will send a first notice in step 914.

Similarly, step 916, the second notice module 44-2 may determine if a second message related to the message information is received. When receiving the second message, the second notice module 44-1 will send a second notice in step 918.

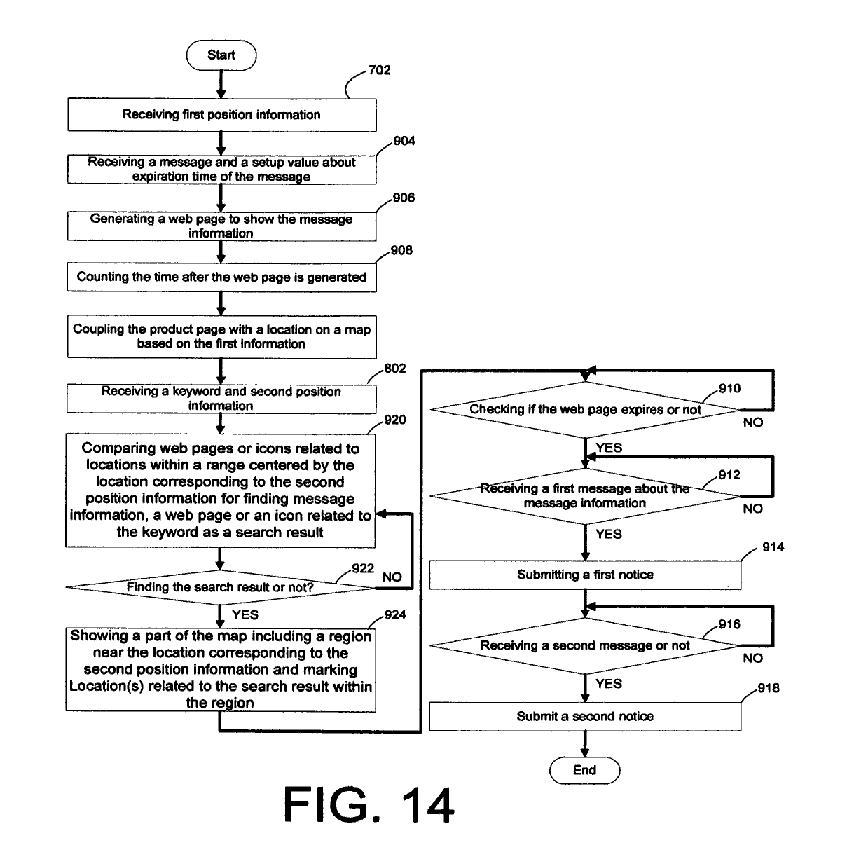

FIG. 14 is a flowchart illustrating a method of providing a location-based service according to yet another example of the present invention. Referring to FIG. 14, except steps 920, 922 and/or 924 the location-based service method described and illustrate with reference to FIG. 14 may be similar to the method described and illustrate with reference to FIG. 9.

In step 920, the search module 15 may search the web pages, the message information, the tags or the icons related to locations within the range centered by the location corresponding to the second position information or near the location on the map corresponding to the second position information to find the message information, the web page, the tag or the icon related to the keyword as the search result.

In step 920, the search module 15 may identify if the search result is found. If the search result is found, the map information module 15 may show the range and mark those related to the search result on the map in the search-result window 31-8 in step 924.

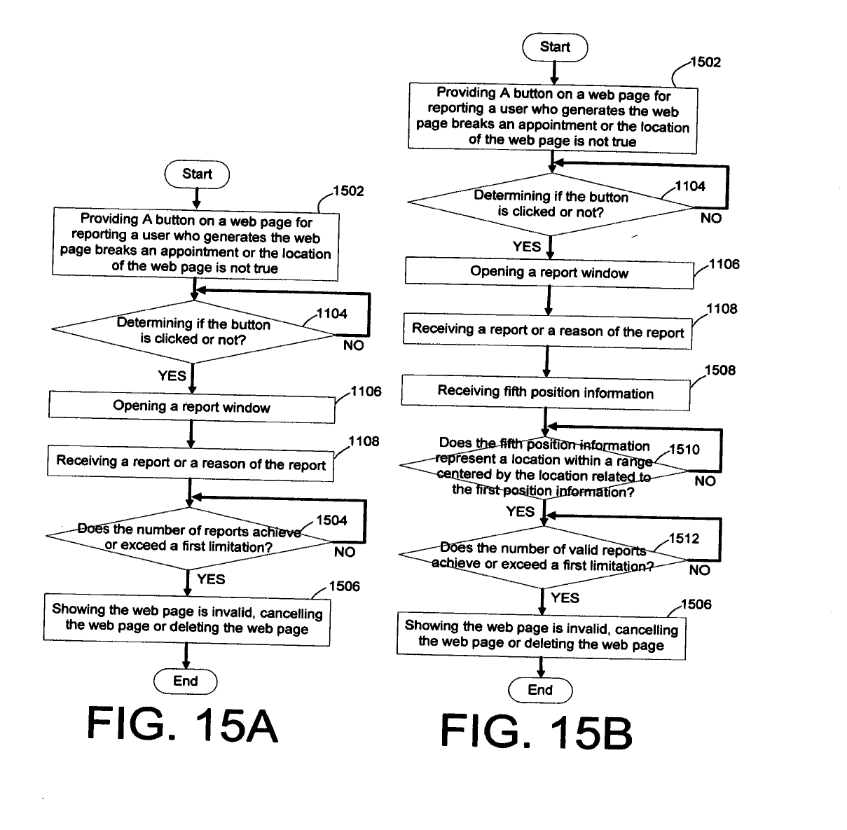

FIG. 15A is a flowchart illustrating a method of providing a location-based service according to still another example of the present invention. Referring to FIG. 15A, in step 1502, management module 42 may provide a report button 588 together with the web page for reporting the user who posts the web page breaks the appointment when generating the web page 46a.

In one example, the web page 46a and the report button 588 may be shown in the window 31-6. The report button 588 may be coupled with the report module 58 to send a report when the report button is pressed, clicked or selected. In another example, after pressing, clicking or selecting the report button 588, the report window 31-10 will be shown.

In step 1104, the report module 58 may identify if the report button 588 is clicked/selected. If “yes,” which means the user reports the web page 46a, go to step 1504. Otherwise if “No,” remain standby and wait for next time the report button is clicked/selected.

In step 1504, the report module 58 may identify if the number of reports that report the location related to the web page 46a is incorrect is larger than or equal to a number limitation (or a maximum number or an upper bound). If “yes,” go to step 1506. If “No,” keep going to accumulate the number of the reports when receiving a new report. When the number of reports is larger than or equal to a number limitation, the report module 58 will cause the management module 42 to execute at least one of showing the web page 46a is invalid (or, showing the location is incorrect), cancelling the web page 46a or withdrawing the web page 46a.

Moreover, in step 1104, if “yes,” then go to step 1106. In step 1106, the report window 31-10 will be opened for the user to generate a report or to enter his/her reason why he/she reports the web page 46a in step 1108.

FIG. 15B is a flowchart illustrating a method of providing a location-based service according to yet another example of the present invention. Referring to FIG. 15B, the location-based service method described and illustrated in connection with FIG. 15B may be similar to the method described and illustrated with reference to FIG. 15A, except that steps 1508, 1510 or 1512 may not be the same.

In step 1508, the report module 58 may receive fifth position information (e.g., its current latitude and longitude) of the second computing device 30 used to send the report. In step 1510, the report module 58 may check if the difference between the fifth position information and the first position information is smaller than or equal to the difference limitation. If the difference between the fifth position information and the first position information is smaller than or equal to the difference limitation (i.e., if “yes” in step 1510), the report will be determined as valid and then go to step 1512.

In step 1512, the report module 58 may count the number of valid reports the web page 46a being reported as its location is incorrect. If the number of valid reports is larger than or equal to the number limitation, the report module 58 will cause the management module 42 to execute at least one of showing the web page 46a is invalid, cancelling the web page 46a or withdrawing the web page 46a.

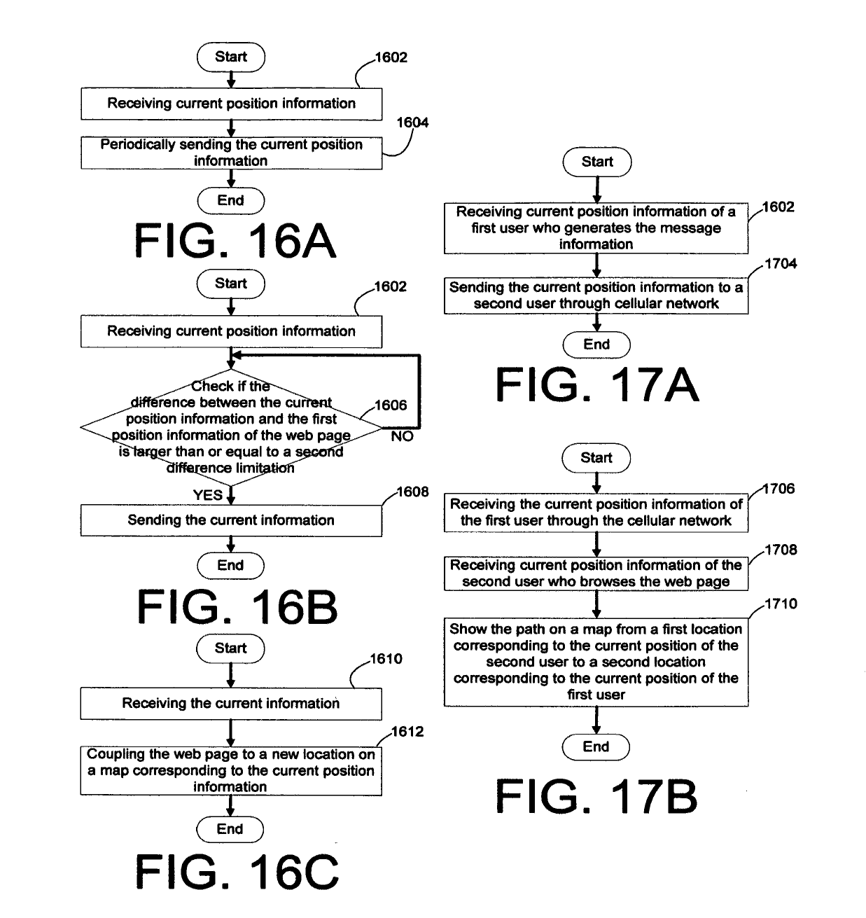

FIG. 16A is a flowchart illustrating a method of providing a location-based service according to still another example of the present invention. Referring to FIG. 16A, in step 1602, when a user (or a seller) login the LBS system 40″′ with his/her account through the first computing device 20, the positioning module 22 of the first computing device 20 may periodically or continuously receive the current position information of the first computing device 20 from the GPS module. In step 1604, the positioning module 22 may periodically or continuously send the current position information of the first computing device 20 to the position module 11 of the LBS system 40″.

Those skilled in the art can easily understand that, in the aforementioned method, step 1604 can be changed to send the current position information of the first computing device 20 only if the difference between the current position information and its previous position information is larger than or equal to a difference limitation, but not periodically or continuously. The method is shown in FIG. 16B. Those skilled in the art can easily understand that applying the method described and illustrated with reference to FIG. 16B may consume less power than applying the method described and illustrated with reference to FIG. 16A.

FIG. 16C is a flowchart illustrating a method of providing a location-based service according to still another example of the present invention. Referring to FIG. 16C, in step 1610, the position module 11 of the LBS system 40″′ may receive updated (or current) position information (sent by the positioning module 22) of the first computing device 20 used to login an account, and the management module 42 may couple a web page generated by the account with a location on the map related to the updated position information in step 1612.

In one example, the management module 42 may be configured to couple the web page generated by the account with a location on the map related to the updated position information only if the difference between the updated position information and its previous position information is larger than or equal to a first difference limitation, or cancel the web page if the difference is larger than or equal to a second difference limitation (which means the seller who login the LBS system 40″′ with the account is too far away from his/her original location setting of its product page).

FIG. 17A is a flowchart illustrating a method of providing a location-based service according to still another example of the present invention. Referring to FIG. 17A, after step 1602 as mentioned above, in step 1704, the positioning module 22 may be configured to send the current position information to the LBS system 40, and then the LBS system 40 will pass the current position information to the second computing device 30, or directly send the current position information to the user's second computing device 30 through the cellular network (e.g., an SMS including the current position information).

FIG. 17B is a flowchart illustrating a method of providing a location-based service according to yet another example of the present invention. Referring to FIG. 17B, in step 1706, the second computing device 30 will receive the current position information. In step 1708, the GPS module or the positioning module 32 of the second computing device 30 may also receive the current position information of the second computing device 30. Next, in step 1710, the second computing device 30 may show the map with a reference path from the current position information of the second computing device 30 to the current position information of the first computing device 20 on its screen 31.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

Further, in describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. An LBS system comprises:
a position module configured to receive first position information;
a management module configured to receive product information, and generate a product page based on the product information, the management module comprises:
a bid module coupled to the product page and configured to receive a bid; and
a map information module configured to couple the product page with a location on a map according the first position information.

2. The system of claim 1, wherein the bid module is configured to set up a sale duration and a minimum reserve,
the bid module being coupled to a bid field of the product page to receive a bid through the bid field,
wherein the bid comprises an offer, the offer is considered to be valid if the price of the offer is larger than or equal to the minimum reserve, and an offer comprising highest price will win the product after the sale duration expires.

3. The system of claim 1, wherein the bid module is configured to set up a buy-it-directly price,
wherein the status of the product shown on the product page will become sold once the bid module receives the bid.

4. The system of claim 1, wherein the status of the product shown on the product page will become reserved once the bid module receives the bid.

5. The system of claim 1, wherein the product page is configured to couple with a communication module, wherein the communication module being configured to receive a question about the product.

6. The system of claim 1 further comprises:
a report module configured to receive a report indicating the location in connection with the product page is incorrect.

7. The system of claim 6, wherein the report module is configured to count the number of reports,
wherein the report module will cause the management module to execute at least one of showing the product page is invalid, cancelling the product page or withdrawing the product page if the number of reports achieves or exceeds a limited number.

8. The system of claim 6, wherein the report module is configured to compare position information of a second computing device used to generate the report and the first position information related to the product page,
wherein the report is determined to be valid if the difference between the two position information is smaller or equal to a difference limitation.

9. The system of claim 1 further comprises:
a registration/login module configured to register position information related to an account when the account is registered,
the registration/login module being configured to compare position information received by the position module when the account tries to login the system with the registered position information, wherein the account is allowed to login if the difference between the two position information is smaller or equal to a difference limitation.

10. The system of claim 1 further comprises:
a registration/login module configured to register position information related to an account when the account is registered,
wherein the management module is configured to compare position information received by the position module when the management module receives the product information with the registered position information,
the product page is generated based on the product information if the difference between the two position information is smaller or equal to a difference limitation.

11. The system of claim 1 further comprises:
a communication module configured to receive a question about the product and an answer about the question; and
a registration/login module configured to register position information related to an account when the account is registered,
wherein the communication module is configured to compare position information received by the position module when communication module receives the answer about the question with the registered position information,
wherein the answer is determined to be valid if the difference between the two position information is smaller or equal to a difference limitation.

12. The system of claim 1, wherein the position module is configured to receive updated position information after the first position information,
wherein the map information module couples the product page with a new location on the map corresponding to the updated position information when the position module receives the updated position information.

13. The system of claim 1 wherein the position module is configured to receive updated position information after the first position information,
wherein the management module executes at least one of showing the product page is invalid, cancelling the product page or withdrawing the product page when the difference between the updated position information and the first position information is larger than or equal to a difference limitation.

14. An LBS system comprises:
a position module configured to receive first position information and updated position information after the first position information;
a management module configured to receive product information, and generate a product page based on the product information; and
a map information module configured to couple the product page with a first location on a map corresponding to the first position information,
wherein the map information module couples the product page with a second location on the map corresponding to the updated position information when the position module receives the updated position information.

15. The system of claim 14, wherein the management module executes at least one of showing the product page is invalid, cancelling the product page or withdrawing the product page when the difference between the updated position information and the first position information is larger than or equal to a difference limitation.

16. The system of claim 14, wherein the product page is configured to couple with a communication module, wherein the communication module being configured to receive a question about the product.

17. The system of claim 14 further comprises:
a report module configured to receive a report indicating the location in connection with the product page is incorrect.

18. The system of claim 17, wherein the report module is configured to count the number of reports,
wherein the report module will cause the management module to execute at least one of showing the product page is invalid, cancelling the product page or withdrawing the product page if the number of reports achieves or exceeds a limited number.

19. The system of claim 17, wherein the report module is configured to compare position information of a second computing device used to generate the report and the first position information related to the product page,
wherein the report is determined to be valid if the difference between the two position information is smaller or equal to a difference limitation.

20. The system of claim 14 further comprises:
a registration/login module configured to register position information related to an account when the account is registered,
the registration/login module being configured to compare position information received by the position module when the account tries to login the system with the registered position information,
wherein the account is allowed to login if the difference between the two position information is smaller or equal to a difference limitation.

21. The system of claim 14 further comprises:
a registration/login module configured to register position information related to an account when the account is registered,
wherein the management module is configured to compare position information received by the position module when the management module receives the product information with the registered position information,
the product page is generated based on the product information if the difference between the two position information is smaller or equal to a difference limitation.

22. The system of claim 14 further comprises:
a communication module configured to receive a question about the product and an answer about the question; and
a registration/login module configured to register position information related to an account when the account is registered,
wherein the communication module is configured to compare position information received by the position module when communication module receives the answer about the question with the registered position information,
wherein the answer is determined to be valid if the difference between the two position information is smaller or equal to a difference limitation.

23. An LBS system comprises:
a position module configured to receive first position information;
a management module configured to receive product information, and generating a product page based on the product information;
a map information module configured to couple the product page with a location on a map according the first position information; and
a report module configured to receive a report indicating the location in connection with the product page is incorrect.

24. The system of claim 23, wherein the report module is configured to count the number of reports about the location in connection with to the product page is reported as incorrect,
wherein the report module will cause the management module to execute at least one of showing the product page is invalid, cancelling the product page or withdrawing the product page if the number of reports achieves or exceeds a limited number.

25. The system of claim 23, wherein the report module is configured to compare position information of a second computing device used to generate the report and the first position information related to the product page,
wherein the report is determined to be valid if the difference between the two position information is smaller or equal to a difference limitation.
